(19) United States
(12) Patent Application Publication
(10) Pub. No.: US 2026/0362469 A1
(43) Pub. Date: Nov. 12, 2026

(54) SOFT RANK PREDICTION

(71) Applicant: QUALCOMM Incorporated, San Diego, CA (US)

(72) Inventors: Mohamed Fouad Ahmed MARZBAN, San Diego, CA (US); Tao LUO, San Diego, CA (US); Narayan PRASAD, Westfield, NJ (US); Wooseok NAM, San Diego, CA (US); Junyi LI, Greentown, PA (US); Sony AKKARAKARAN, Poway, CA (US)

(21) Appl. No.: 19/203,122

(22) Filed: May 8, 2025

(51) Int. Cl. H04W 72/563; H04B 7/06; H04W 72/54

(52) U.S. Cl. CPC H04W 72/563; H04B 7/0626; H04W 72/54

(57) ABSTRACT

Systems and techniques are provided for wireless communications. For example, an apparatus for wireless communication at a user equipment (UE) can receive configuration information associated with soft rank prediction by the UE, where the configuration information is indicative of a first set of resources and a second set of resources. The apparatus can determine channel measurement information corresponding to the first set of resources, and can use the channel measurement information to determine soft rank prediction information corresponding to the second set of resources. The soft rank prediction information includes one or more predicted soft rank values for the second set of resources. The apparatus can transmit, via a transceiver, signaling indicative of the soft rank prediction information.

### INTRODUCTION

Aspects of the present disclosure generally relate to wireless communication. In some implementations, examples are described for determining and/or reporting information corresponding to a soft rank prediction associated with a user equipment (UE).

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, an apparatus for wireless communication at a user equipment (UE) is provided. The apparatus includes a processing system and a transceiver in communication with the processing system, the processing system configured to: receive configuration information associated with soft rank prediction by the UE, wherein the configuration information is indicative of a first set of resources and a second set of resources; determine channel measurement information corresponding to the first set of resources; determine, based on the channel measurement information, soft rank prediction information corresponding to the second set of resources, wherein the soft rank prediction information includes one or more predicted soft rank values for the second set of resources; and transmit, via the transceiver, signaling indicative of the soft rank prediction information.

In another example, a method for wireless communication is provided, the method including: receiving configuration information associated with soft rank prediction by a user equipment (UE), wherein the configuration information is indicative of a first set of resources and a second set of resources; determining channel measurement information corresponding to the first set of resources; determining, based on the channel measurement information, soft rank prediction information corresponding to the second set of resources, wherein the soft rank prediction information includes one or more predicted soft rank values for the second set of resources; and transmitting, via a transceiver, signaling indicative of the soft rank prediction information.

In another example, a non-transitory computer-readable storage medium is provided comprising instructions stored thereon which, when executed by at least one processor, causes the at least one processor to: receive configuration information associated with soft rank prediction by a user equipment (UE), wherein the configuration information is indicative of a first set of resources and a second set of resources; determine channel measurement information corresponding to the first set of resources; determine, based on the channel measurement information, soft rank prediction information corresponding to the second set of resources, wherein the soft rank prediction information includes one or more predicted soft rank values for the second set of resources; and transmit, via a transceiver, signaling indicative of the soft rank prediction information.

In another example, an apparatus is provided for wireless communication. The apparatus includes: means for receiving configuration information associated with soft rank prediction by a user equipment (UE), wherein the configuration information is indicative of a first set of resources and a second set of resources; means for determining channel measurement information corresponding to the first set of resources; means for determining, based on the channel measurement information, soft rank prediction information corresponding to the second set of resources, wherein the soft rank prediction information includes one or more predicted soft rank values for the second set of resources; and means for transmitting, via a transceiver, signaling indicative of the soft rank prediction information.

According to at least one illustrative example, an apparatus for wireless communication at a network entity is provided. The apparatus includes a processing system and a transceiver in communication with the processing system, the processing system configured to: transmit, via the transceiver, configuration information associated with soft rank prediction by a user equipment (UE), wherein the configuration information is indicative of a first set of resources and a second set of resources, and wherein the configuration is transmitted to the UE; receive, from the UE, soft rank prediction information corresponding to the second set of resources, wherein the soft rank prediction information includes one or more predicted soft rank values determined for the second set of resources based on channel measurements of the first set of resources; and transmit, via the transceiver, a downlink transmission to the UE, wherein the downlink transmission uses the second set of resources and is configured based on the soft rank prediction information.

In another example, a method for wireless communication is provided, the method including: transmitting, via a transceiver, configuration information associated with soft rank prediction by a user equipment (UE), wherein the configuration information is indicative of a first set of resources and a second set of resources, and wherein the configuration is transmitted to the UE; receiving, from the UE, soft rank prediction information corresponding to the second set of resources, wherein the soft rank prediction information includes one or more predicted soft rank values determined for the second set of resources based on channel measurements of the first set of resources; and transmitting, via the transceiver, a downlink transmission to the UE, wherein the downlink transmission uses the second set of resources and is configured based on the soft rank prediction information.

In another example, a non-transitory computer-readable storage medium is provided comprising instructions stored thereon which, when executed by at least one processor, causes the at least one processor to: transmit, via a transceiver, configuration information associated with soft rank prediction by a user equipment (UE), wherein the configuration information is indicative of a first set of resources and a second set of resources, and wherein the configuration is transmitted to the UE; receive, from the UE, soft rank prediction information corresponding to the second set of resources, wherein the soft rank prediction information includes one or more predicted soft rank values determined for the second set of resources based on channel measurements of the first set of resources; and transmit, via the transceiver, a downlink transmission to the UE, wherein the downlink transmission uses the second set of resources and is configured based on the soft rank prediction information.

In another example, an apparatus is provided for wireless communication. The apparatus includes: means for transmitting, via a transceiver, configuration information associated with soft rank prediction by a user equipment (UE), wherein the configuration information is indicative of a first set of resources and a second set of resources, and wherein the configuration is transmitted to the UE; means for receiving, from the UE, soft rank prediction information corresponding to the second set of resources, wherein the soft rank prediction information includes one or more predicted soft rank values determined for the second set of resources based on channel measurements of the first set of resources; and means for transmitting, via the transceiver, a downlink transmission to the UE, wherein the downlink transmission uses the second set of resources and is configured based on the soft rank prediction information.

Aspects generally include a method, apparatus, system, computer program product, non-transitory computer-readable medium, user equipment, base station, wireless communication device, and/or processing system as substantially described herein with reference to and as illustrated by the drawings and specification. The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIG. 6 is a call flow diagram illustrating an example of a process for soft rank prediction associated with a network entity and a UE, in accordance with some examples;

FIG. 7 is a flow diagram illustrating an example of a process for wireless communication associated with a UE, in accordance with some examples;

FIG. 8 is a flow diagram illustrating an example of a process for wireless communication associated with a network entity, in accordance with some examples; and

FIG. 9 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In wireless communication systems, a channel rank represents a quantity of signal paths or spatial streams supported by a transmission channel. The channel rank, which may be determined in accordance with measured channel characteristics such as signal-to-noise ratio and a correlation between received signals, may provide an indication of the channel's spatial multiplexing capability. A network may use the channel rank to select resources for transmission of uplink communications and downlink communications.

A wireless device may support Multiple Input Multiple Output (MIMO) transmission schemes to perform transmission using multiple independent data streams (e.g., layers, also referred to as spatial layers) that may be transmitted simultaneously using different antennas or antenna ports of the wireless device. Multi-layer MIMO can be used to refer to spatial multiplexing of the multiple data streams onto a corresponding set of multiple transmission layers (e.g., spatial layers). In various wireless communication networks (e.g., 4G/LTE, 5G/NR, 6G, and beyond), communication links may use multiple-input multiple-output (MIMO) configurations and/or MIMO antenna technology, including spatial multiplexing, beamforming, and/or various other techniques for increasing transmit diversity. MIMO communications may use multiple antennas at both the transmitter (e.g., multiple Tx antennas) and at the receiver (e.g., multiple Rx antennas), with a plurality of different signal propagation paths between the different unique combinations of Tx antenna and Rx antenna pairs. MIMO channels can be represented using a channel matrix that corresponds to the respective spatial correlations between the different transmit and receive antennas of a MIMO system or channel, with the dimensions of the channel matrix indicative of the antenna configuration. For example, a 4×4 channel matrix can correspond to a 4×4 MIMO configuration with four transmit antennas and four receive antennas, etc.

In some examples, MIMO may be configured for single-user (SU) operation (e.g., SU-MIMO) and/or can be configured for multi-user (MU) operation (e.g., MU-MIMO), where SU-MIMO corresponds to communications with a single UE or network device, and MU-MIMO can be used for simultaneous transmission to multiple UEs or network devices. Various codeword structures can be used for MIMO communications, based at least in part on the mapping between codewords and the spatial layers associated with a MIMO communication link. For example, the spatial layers of a MIMO communication link can correspond to the independent spatial transmission paths that can carry data streams through the wireless medium (e.g., each spatial layer of the MIMO communication link can correspond to a unique pair of transmit and receive antennas, etc.). The transmitting device can perform layer mapping to distribute portions of a signal to be transmitted across the different respective spatial layers of the MIMO communication link, with the layer mapping performed before precoding and transmission for each respective spatial layer using the corresponding Tx-Rx antenna's spatial transmission path. In SU-MIMO, the number of streams of information flow from a transport block (TB) can be equal to the number of spatial layers. In MU-MIMO, the number of streams may be equal to the total number of spatial layers across all users of the multiple users of an MU-MIMO communication link.

A channel rank is a measure of a maximum number of independent data streams that a MIMO channel can support. The channel rank may be determined by analyzing linear independence of the channel's transfer matrix components, which represent various spatial paths between the transmitter and the receiver. For example, the channel rank can be determined by the rank of the channel transfer matrix, which represents the number of linearly independent rows or columns within the channel transfer matrix. In legacy wireless communication systems that support MIMO communication, the channel rank has been represented as an integer, with a maximum value of the quantity of outputs or the quantity of inputs (whichever is lower) of a MIMO channel. For example, a MIMO channel with M outputs and N inputs may have a maximum rank that is an integer value constrained by min(M, N). By limiting the channel rank to an integer, it is possible for two MIMO channels to have the same channel rank even though the channels may not have equal conditions for communication between, for example, a user equipment (UE) and a network entity (e.g., base station, gNB, etc.). Additionally, legacy wireless communication systems limit the determination of channel rank to particular criteria. Therefore, channel selection based on the channel rank cannot be tailored to different scenarios (e.g., avoiding interference).

In some examples, channel rank for a MIMO system associated with a channel matrix H can be determined as rank(H), equal to the number of non-zero singular values of the channel matrix H. Non-singular values of H may be equal to the number of linearly independent rows or columns in H. As noted above, in some wireless networks, channel rank may be a positive integer value. Soft channel rank (e.g., also referred to as “soft rank”) can be implemented as a continuous-valued and/or probabilistic measure of the usable spatial dimensions of a MIMO channel. Soft rank values may be non-integer values, as well as integer values. For example, the soft rank may be a non-negative real number associated with the quantity of outputs and quantity of inputs for a MIMO channel. In some aspects, a UE may report the soft rank for the MIMO channel using configured or indicated metrics. The soft channel rank can be determined from multiple inputs, which may include channel condition information, signal-to-noise ratio (SNR), and/or the strength(s) of singular values, etc., among various others. Soft channel rank values can be indicative of how evenly channel energy is spread or distributed across a set of spatial streams. For example, when a respective singular value dominates, the soft channel rank may be determined with a value near 1. When the respective singular values are equal or similar to one another, the value of the soft channel rank may approach that of the integer-constrained channel rank, rank(H).

In some cases, a UE may be configured to perform soft rank reporting, where the UE determines a soft rank measurement for one or more channels or configured sets of resources (e.g., time-frequency resources) and reports the soft rank measurement(s) to a network entity (e.g., base station, gNB, etc.). The reported soft rank measurement(s) can indicate, to the network entity, the effective channel conditions perceived or experienced by the UE. The network entity can use the reported soft rank measurements from the UE to differentiate between two or more channels that are evaluated as candidate channels for scheduling one or more transmissions between the network entity and the UE. In some cases, a soft rank measurement report form the UE may be supplemented by one or more CSI feedback transmissions from the UE to the network entity, for example where the one or more CSI feedback transmission are indicative of additional channel condition information (e.g., such as precoding matrix indicators (PMIs) and/or channel quality indicators (CQIs), etc.). Systems and techniques that can be used to provide soft rank prediction and reporting between a UE and a network entity (e.g., base station, gNB, etc.) may be beneficial. For example, soft rank prediction and reporting may be beneficial based on energy savings associated with a reduced number of measurements when soft rank prediction information is determined by a UE and reported from the UE to a network entity.

Systems, apparatuses, processes (also referred to as methods), and computer-readable media (collectively referred to as “systems and techniques”) are described herein that can be used to provide soft rank prediction for a MIMO channel associated with a UE and a network entity (e.g., base station, gNB, etc.). In some examples, the systems and techniques can be used to provide soft rank prediction and reporting of one or more soft rank predictions associated with the MIMO channel. In some examples, the UE may perform the soft rank prediction based on configuration information received from a network entity, and the UE can report the soft rank prediction to the network entity. In some cases, the soft rank prediction can be determined corresponding to one or more sets of configured resources (e.g., time-frequency resources) of the MIMO channel. For example, the configuration information received from the network entity can be indicative of the one or more sets of configured resources for the soft rank prediction.

For example, a UE can determine a soft rank prediction including one or more predicted soft rank values for a set of resources indicated based on configuration information received from a network entity, and the UE can transmit signaling indicative of the soft rank prediction information to the network entity. The configuration information can be received from the network entity, and can comprise configuration information associated with soft rank prediction by the UE. The configuration information can be indicative of at least a first set of resources and a second set of resources. For example, the first set of resources can be a first set or group of channel measurement resources, such as synchronization signal blocks (SSBs), CSI-reference signals (CSI-RSs), etc. The second set of resources can be a second set or group of channel measurement resources. In some cases, the first set of resources can be configured as measurement resources associated with and used by the UE for the soft rank prediction. The second set of resources can be configured as prediction resources associated with and used by the UE for the soft rank prediction. For example, the UE can be configured to measure the channel and/or interference on the group of measurement resources (e.g., first set of resources indicated by the configuration information), and to predict the soft rank value(s) on the group of prediction resources (e.g., second set of resources indicated by the configuration information). The UE can transmit a soft rank prediction report indicative of the predicted soft rank value(s) on the group of prediction resources, and/or subsets thereof.

In some cases, the first set of resources indicated by the configuration information can comprise a plurality of channel measurement resources associated with the MIMO channel, and the second set of resources comprises a plurality of prediction resources associated with the MIMO channel. The first and second sets of resources (e.g., measurement and prediction resources, respectively) can vary in one or more of time, frequency (e.g., sub-channels, component carriers (CCs), and/or bandwidth parts (BWPs), etc.), and/or space (e.g., beams, spatial layer or streams, etc.). In some examples, the UE can perform the soft rank prediction according to one or more soft rank prediction metrics and/or configurations indicated by the network entity using the configuration information. For example, the soft rank prediction can be based on channel prediction only, channel prediction and interference prediction, channel measurement and interference prediction, channel prediction and interference measurement, etc. In some cases, the UE can determine one or more predicted soft rank values corresponding to one or more resources of the second set of resources (e.g., prediction resources). The predicted soft rank values may be reported from the UE to the network entity via signaling indicative of the soft rank prediction information including the one or more predicted soft rank values. In some cases, the predicted soft rank values can be reported from the UE to the network entity using a CSI report, where the CSI report is extended to include the predicted soft rank values and/or other soft rank prediction information. In some cases, the predicted soft rank values can be transmitted from the UE to the network entity via signaling combining the soft rank prediction information with various other measured and/or predicted CSI values or information, etc.

In some examples, the first set of resources can be configured as a group of measurement resources, comprising one or multiple sets (e.g., subsets) of measurement resources for the soft rank prediction by the UE. For example, the first set of resources can comprise one group of channel measurement resources (e.g., SSB, CSI-RS, etc.), and the UE can be configured to determine channel measurement information based on measuring the channel on the group of channel measurement resources. In some cases, the UE may additionally be configured to measure or predict interference information on the group of channel measurement resources. In some cases, the first set of resources can comprise a first subset of measurement resources and a second subset of measurement resources, where the first subset of measurement resources includes channel measurement resources (e.g., SSB, CSI-RS, etc.) and the second subset of measurement resources includes inter-cell interference measurement resources (e.g., CSI interference measurement (CSI-IM), etc.). The UE can measure the channel to determine channel measurement information corresponding to the first subset of measurement resources, and can measure the interference (e.g., inter-cell interference) on the CSI-IM or other interference measurement resources of the second subset of measurement resources. In some cases, the first set of resources (e.g., group of measurement resources) may include a third subset of measurement resources, where the third subset of measurement resources comprises resources for MU-MIMO interference measurement(s). For example, the third subset of MU-MIMO interference measurement resources can include non-zero-power (NZP) CSI-RS resources, CSI-IM resources, etc. The UE can be configured to measure the MU-MIMO interference on the third set of resources.

In some cases, the second set of resources can be configured as a group of prediction resources corresponding to the soft rank prediction by the UE. For example, the group of prediction resources can comprise one or more subsets of prediction resources. For example, the group of prediction resources can comprise a single subset (e.g., where the single subset is the same as the group of prediction resources) of prediction resources, which the UE can use to report a predicted soft rank based on predicting the channel on the group of prediction resources. In some cases, the UE may predict the channel and the interference on the group of prediction resources, and can report predicted soft rank information based on the channel prediction and the interference prediction. In some cases, the group of prediction resources includes a first and second subset of prediction resources, and the UE can be configured to determine channel prediction information corresponding to the first subset of prediction resources and to determine inter-cell interference predictions corresponding to the second subset of prediction resources. The UE can determine, and report to the network entity, a predicted soft rank information based on the channel prediction(s) on the first subset of prediction resources and then inter-cell interference prediction(s) on the second subset of prediction resources. In some cases, the group of prediction resources can include a third subset of prediction resources, and the UE can be configured to use the third subset of prediction resources for MU-MIMO interference prediction(s), and the soft rank prediction information can be determined using the MU-MIMO interference prediction(s).

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, a processing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, processing system, or the like may include disclosure of the UE, base station, apparatus, device, computing system, processing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first processing system, a first one or more components, a first processing entity, or the like configured to receive the information; and the second network node may refer to a second UE, a second base station, a second apparatus, a second device, a second computing system, a second processing system, a second one or more components, a second processing entity, or the like.

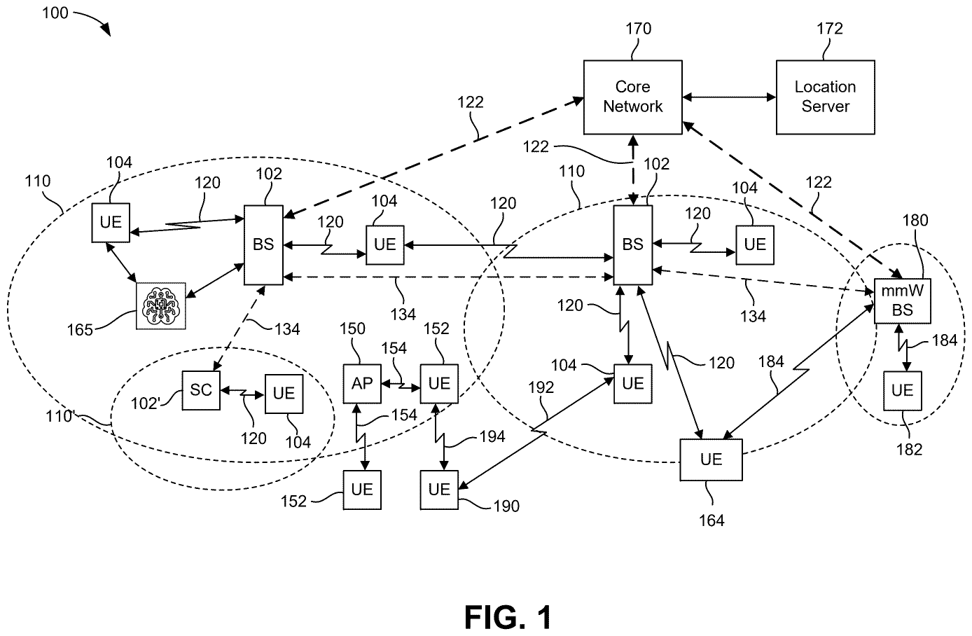

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, a processing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network wireless communications system of FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, processing system or the like may include disclosure of the UE, base station, network node, apparatus, device, computing system, processing system or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first processing system, a first set of one or more one or more components, a first processing entity, or the like configured to receive the information; and the second network entity may refer to a second UE, a second base station, a second apparatus, a second device, a second computing system, a second processing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

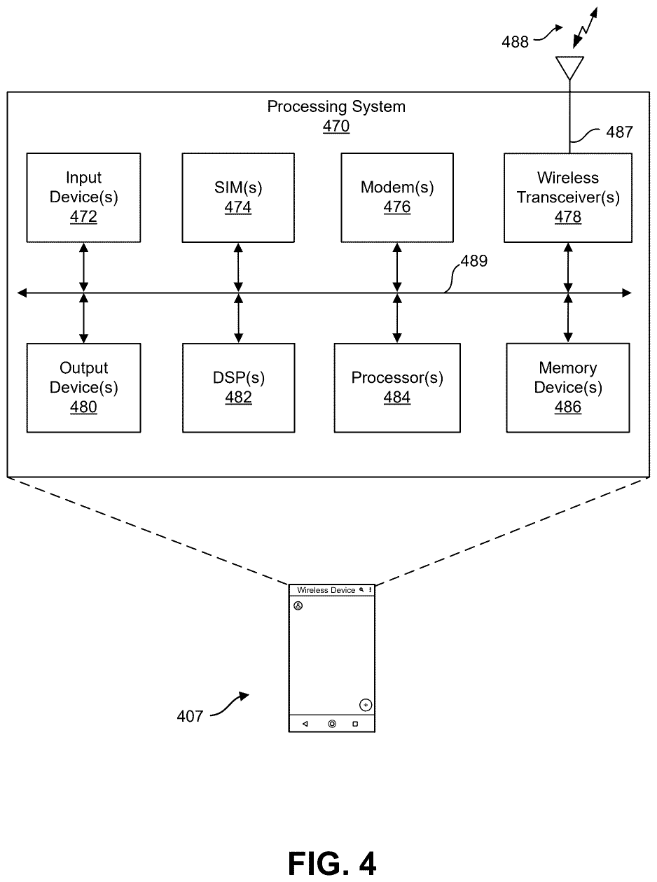

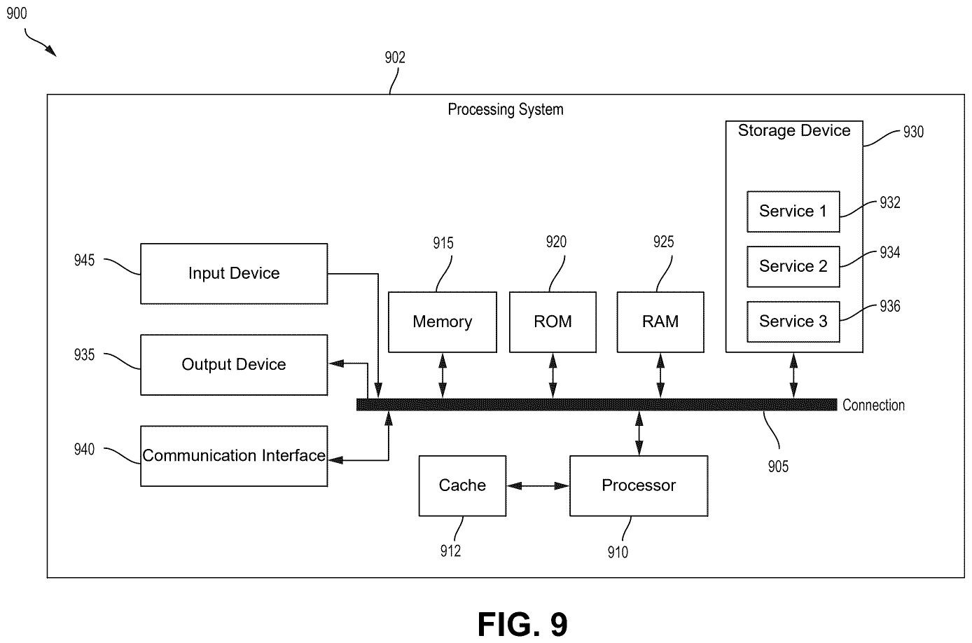

In some examples, the network entity 102 may include a processing system (e.g., such as the processing system 470 of FIG. 4 and/or the processing system 902 of FIG. 9, etc.). Similarly, the network entity 180 (e.g., a millimeter wave (mmW) base station, etc.) may include a respective processing system (e.g., such as the processing system 470 of FIG. 4 and/or the processing system 902 of FIG. 9, etc.). A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, a UE 104 and a network entity (e.g., base station 102) may perform MIMO communication. MIMO communication generally refers to transmitting or receiving multiple signals (such as multiple layers or multiple data streams) simultaneously over the same time and frequency resources. A base station 102 or a UE 104 may communicate using single-user MIMO or multi-user MIMO (MU-MIMO), the latter of which may be used by a base station 102 to simultaneously transmit signals to multiple UEs 104. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a base station 102 may generate one or more beams, and a UE 104 may generate one or more beams. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a base station 102 or a UE 104 may implement massive MIMO, which may be associated with an increased (for example, “massive”) quantity of antennas at the base station 102 or at the UE 104, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The base station 102 and the UE 104 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the base station 102 transmitting signals (for example, SSBs or other signals) via respective beams and the UE 104 receiving and measuring the signal(s) via respective beams of multiple beams to identify a best beam (or beam pair) for communication between the UE 104 and the base station 102. Abeam refinement operation may involve a first device (for example, the UE 104 or the base station 102) transmitting signal(s) via a subset of beams (for example, identified based on, or otherwise associated with, measurements reported as part of one or more other beam management operations). A second device (for example, the base station 102 or the UE 104) may receive the signal(s) via a single beam (for example, to identify the best beam for communication from the subset of beams). The beam(s) may be identified or defined via one or more spatial parameters, such as a transmission configuration indicator (TCI) state or a quasi-colocation (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more base stations 102, one or more UEs 104, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 104 (for example, by a respective processing system of the UE 104, etc.), a base station 102 (for example, by a respective processing system of the base station 102, etc.), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 104 and a second portion of the AI/ML model may be deployed at a base station 102). In other examples of coordinated AI/ML or native AI/ML, a first AI/ML model may be deployed at a UE 104 and a second AI/ML model may be deployed at a base station 102. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 104, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

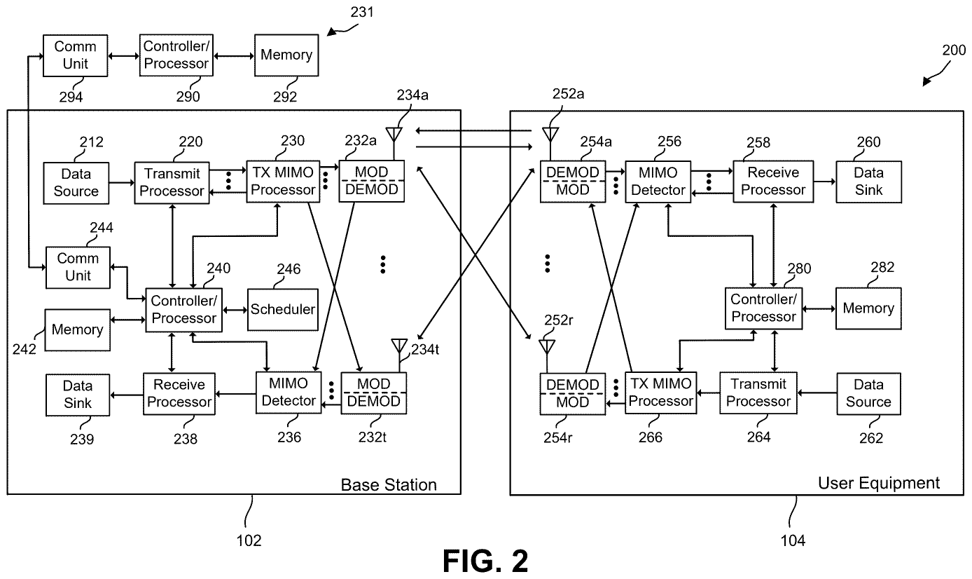

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit Uplink Control Information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

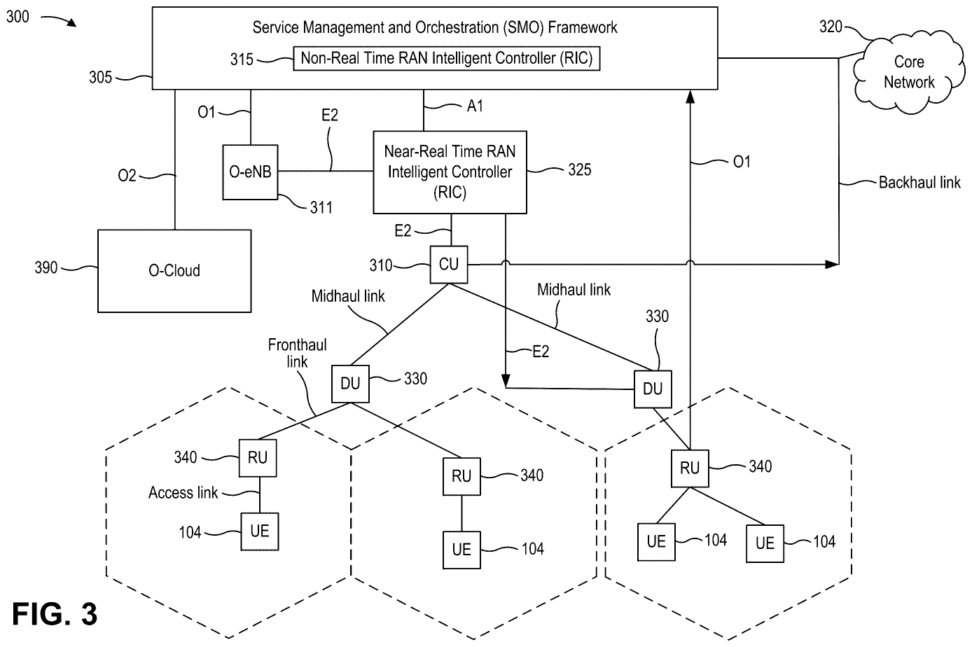

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

FIG. 4 illustrates an example of a processing system 470 of a wireless device 407. In some examples, the processing system 470 may also be referred to as a computing system. The processing system 470 may include and/or implement one or more components that are the same as or similar to respective components included in and/or implemented by the processing system 902 of FIG. 9 (e.g., and the processing system 902 of FIG. 9 may include and/or implement one or more components that are the same as or similar to respective components included in and/or implemented by the processing system 470 of FIG. 4). In some cases, the wireless device 407 may also be referred to as a user computing device. The wireless device 407 may include a client device such as a UE (e.g., UE 104, UE 152, UE 190) or other type of device (e.g., a station (STA) configured to communication using a Wi-Fi interface) that may be used by an end-user. In some cases, the processing system 470 of the wireless device 407 can be implemented by one or more of the UEs 104 of FIG. 1. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network.

The processing system 470 includes software and hardware components that may be electrically or communicatively coupled via a bus 489 (e.g., or may otherwise be in communication, as appropriate). The processing system 470 may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, the processing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

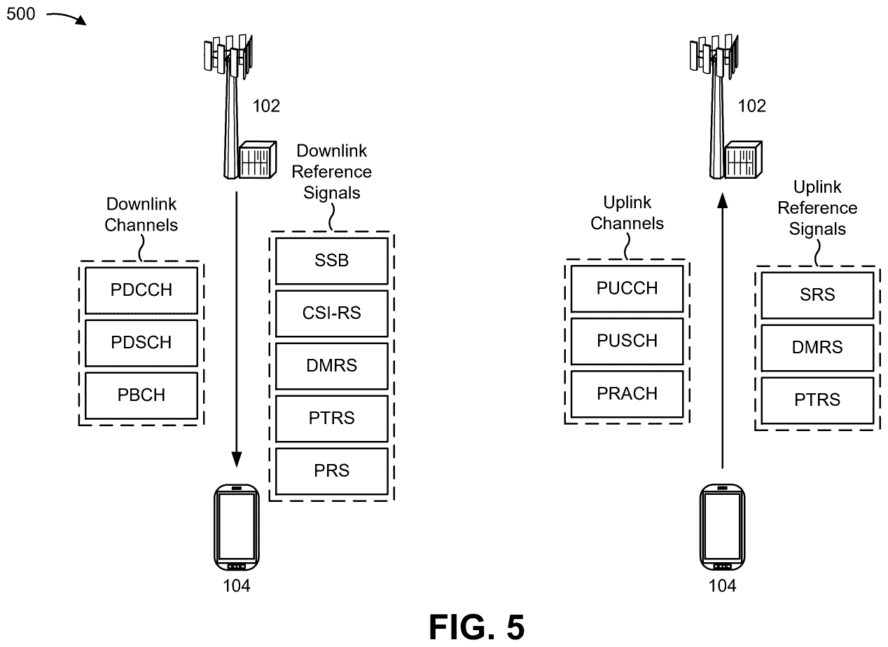

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102. In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications. In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples. An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples. In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications. A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104. In some cases, a UE may receive a reference signal (e.g., a CSI-RS, an SSB, a DMRS, etc.) from a network entity (or another UE) and can report channel state feedback (CSF) to the network entity (or the other UE), where the CSF is determined based on measurements of the reference signal received at the UE. In some cases, a UE may also transmit a reference signal (e.g., CSI-RS, DMRS, PT-RS, SRS, etc.), and a network entity (or another UE) may determine characteristics associated with the channel based on measurements of the received reference signal.

In some cases, the time and frequency resources that may be used by a UE to report CSI can be controlled by a network entity (e.g., base station, gNB, etc.). CSI may comprise one or more of a Channel Quality Indicator (CQI), a precoding matrix indicator (PMI), a CSI-RS resource indicator (CRI), an SS/PBCH Block Resource indicator (SSBRI), a layer indicator (LI), a rank indicator (RI), L1-RSRP, L1-SINR, a CapabilityIndex, and/or time-domain channel properties (TDCP), among various others. In some cases, for one or more of CQI, PMI, CRI, SSBRI, LI, RI, L1-RSRP, L1-SINR, CapabilityIndex, and/or TDCP, a UE may be configured by higher layers with N≥1 CSI-ReportConfig Reporting Settings and/or X≥1 LTM-CSI-ReportConfig Reporting Settings, M≥1 CSI-ResourceConfig Resource Settings and/or Y≥1 LTM-CSI-ResourceConfig Resource Settings, and one or two list(s) of trigger states (given by the higher layer parameters CSI-AperiodicTriggerStateList and CSI-SemiPersistentOnPUSCH-TriggerStateList).

In wireless communication systems, a channel rank can represent a quantity of signal paths or spatial streams supported by a transmission channel. The channel rank, which may be determined in accordance with measured channel characteristics such as signal-to-noise ratio and a correlation between received signals, may provide an indication of the channel's spatial multiplexing capability. A network may use the channel rank to select resources for transmission of uplink communications and downlink communications. In some examples, a channel rank is a measure of a maximum number of independent data streams that a MIMO channel can support. The channel rank may be determined by analyzing linear independence of the channel's transfer matrix components, which represent various spatial paths between the transmitter and the receiver. For example, the channel rank can be determined by the rank of the channel transfer matrix, which represents the number of linearly independent rows or columns within the channel transfer matrix. In legacy wireless communication systems that support MIMO communication, the channel rank has been represented as an integer, with a maximum value of the quantity of outputs or the quantity of inputs (whichever is lower) of a MIMO channel. For example, 5G NR systems may be configured with a restriction that the rank report by a UE (e.g., for the serving or candidate cells of the UE) be restricted to integer values of channel rank. For example, a MIMO channel with M outputs and N inputs may have a rank selected as an integer in {1, . . . , min(M, N)}. Based on the integer implementation of channel rank values, a common (e.g., same) integer-valued channel rank may be used for two different channels corresponding to two different modes over the same point-to-point link, and the integer-valued channel rank is not a metric with differentiation between the two different channels. In some examples of 5G NR systems, selection rules may be implemented based on a noise-plus-interference covariance measurement (e.g., an Rₙₙ matrix). The Rₙₙ matrix can represent the noise-plus-interference covariance measurement (e.g., matrix) at a receiver, and may be used for various techniques, including rank estimation, singular value decomposition (SVD) of the channel matrix H, determining eigenvalues and/or performing minimum mean square error (MMSE)-based channel estimation, etc. For selection rules that are based on the Rₙₙ matrix, or other representations of the noise-plus-interference experienced by the UE (e.g., receiver), channel rank implementations may be based on heavily averaged noise and interference covariance to prevent the occurrence of interference-dependent fluctuations.

Flexible and efficient soft rank reporting of channel soft rank values measured and/or determined by a UE may improve the latency and/or information density (e.g., information availability, etc.) for a network entity that performs one or more actions, or makes one or more determinations, based on the effective channel condition information perceived and reported by a UE. For example, soft rank metrics for rank selection may be extended into a selection from a set of positive, real-valued (e.g., integer and non-integer) numbers, which can improve network differentiation between two different channels, based on the two different channels being associated with different respective real-valued channel soft rank metrics. In some cases, channel soft rank measurements or metrics can be used for an initial assessment or determination by the network, with an initial soft rank report later refined based on additional CSI feedback information obtained by the network (e.g., PMIs, CQIs, etc.).

In some examples of soft rank metrics and/or soft rank measurements for a MIMO channel, a UE can be configured with soft rank reporting for DL transmissions or signals received by the UE from a network entity (e.g., base station, gNB, etc.). For example, for a MIMO channel with M outputs and N inputs, the soft rank value can be any non-negative value that does not exceed (e.g., is less than or equal to) min(M, N). In some cases, the network entity may configure the UE to enable soft rank reporting for DL transmissions. In some examples of channel soft rank measurement and/or soft rank metrics, an indication from a network entity and/or other serving cell indication may be used to determine a particular choice of metric for soft rank selection and/or calculation (e.g., determination) by a UE. For example, the UE can be configured with multiple metrics for soft rank selection, where different metrics for the soft rank selection may correspond to different scenarios. In some cases, the soft rank metric can be determined using at least channel measurements obtained by the UE over a configured one or more reference signals (RSs), such as CSI-RS and/or channel measurement resources (CMRs), etc.

In some examples of soft rank measurement and/or soft rank metric selection or configuration, a UE may transmit, and a network entity may receive, a metric request or a metric notification. For example, the UE may transmit a request for a configuration or indication identifying a metric for the UE to use for soft rank selection (e.g., a metric for the UE to use when determining the soft rank of a MIMO channel). In another example, the UE may transmit the metric notification to indicate, to the network entity, a metric that the UE intends to use for determining the soft rank of the MIMO channel. In some cases, the UE may be configured to apply the metric indicated via the metric notification after a time offset. The UE may indicate the time offset to the network entity to give the network entity an opportunity to provide a different metric for determining the soft rank. In some cases, the UE may transmit the metric request or the metric notification via UE assistance information signaling such as UCI, a MAC-CE, an RRC message, or a combination thereof, among other examples. In some examples, the UE may be configured to detect a triggering event and transmit the metric request or metric notification as a result of detecting the triggering event. For example, the triggering event may include a variation of a noise-plus-interference covariance (e.g., Rₙₙ matrix) measurement, a channel variation, or a combination thereof, among other examples. In some cases, the UE may be configured to apply the metric after a time offset or in accordance with a configuration or indication received from the network entity.

In some examples of soft rank measurement and configuration, the network entity may transmit, and the UE may receive, one or more configurations or indications associated with soft rank selection for a MIMO channel. The soft rank can be a non-negative real number associated with a quantity of output ports and a quantity of input ports of a MIMO channel. One or more parameters of the soft rank configuration may be associated with one or more channel measurements, and/or may be associated with one or more Rₙₙ measurements or indications, and/or may be associated with one or more of a transmit power measurement or indication, and/or may be associated with one or more measurements or indications based, at least in part, on a ratio of data-to-reference signal symbol transmit power. In some cases, the UE may receive (e.g., via RRC messaging, etc.) a scalar quantization indication indicating a scalar quantization codebook associated with the soft rank. In some cases, the soft rank configuration may be associated with a band or sub-band of a MIMO channel for determining the soft rank, and the band or sub-band for determining the soft rank may be reconfigurable. In some examples, the soft rank configuration can include one or more rules associated with reporting a dominant singular value set. The dominant singular value set may include one or more of all non-zero singular values, all singular values with a magnitude that satisfies a threshold, a smallest set of singular values with a sum power that satisfies a threshold, or a quantity of singular values corresponding to the soft rank.

In examples of soft rank measurement and configuration, a UE may apply one or more of the metrics or parameters indicated or configured by the network entity. In some examples, the UE may apply one or more of the metrics or parameters to determine the soft rank of the MIMO channel for the serving cell or the candidate cell. For example, the UE may configure itself in accordance with one or more configurations transmitted by the network entity. In some cases, the UE may use the metric indicated via the metric indication or the metric notification. In examples of soft rank measurement and configuration, the network entity may transmit, and the UE may receive, one or more reference signals. In some examples, the one or more reference signals may correspond to the metric for determining the soft rank of the MIMO channel. For example, if the metric corresponds to using a measured or estimated channel, the reference signal may be a CSI-RS. Further, if the metric is associated with measuring the noise-plus-interference covariance matrix Rₙₙ, the reference signal may point to an interference measurement resource or may be a CSI-RS transmitted by a neighbor cell, which is to be considered by the UE as a source of interference. In the latter case a spreading sequence used to scramble the neighbor cell CSI-RS may be conveyed to the UE.

In examples of soft rank measurement and configuration, the network entity may transmit, and the UE may receive, one or more resource allocations configured to allocate or provision one or more resources for one or more interference measurements to be performed by the UE (e.g., measurement of interference by a neighboring cell). In some examples of soft rank measurement and configuration, the network entity may provision or allocate resources for the interference measurement before transmitting the reference signal. In some examples of soft rank measurement and configuration, the UE may measure the reference signal, where measurements of the reference signal may occur in accordance with the one or more resources allocated or provisioned by the network entity. For example, the UE may measure the CSI-RS or another reference signal transmitted by the network entity.

In examples of soft rank measurement and configuration, the UE may determine a measurement of the soft rank of the MIMO channel (e.g., a measured soft rank, measured soft rank value, soft rank measurement, etc.). For example, the soft rank measurement may be performed or determined in accordance with a noise-plus-interference measurement, a transmit power, or a combination thereof, among other examples. For example, for a MIMO channel H with M outputs and N inputs, and with non-zero singular values defined as {σ₁, . . . , σ_{Q}} for 1≤Q≤min(M, N) where Q is a rank (e.g., an integer), the soft rank of H may be determined using the configured or indicated metric and will not be restricted to be an integer. In some cases, the soft rank value can be a non-zero real number in an interval [1, Q]. Alternatively, in some cases, the soft rank may be configured to have a value that does not exceed a value of the rank Q. In some examples, the soft rank value measured by a UE may be scale invariant. For example, when the soft rank metric is scale invariant, the two MIMO channels H and γH may have the same soft rank for any scaling factor γ>0.

In some examples, a soft rank metric may be a Schur-concave function of one or more singular values σ. In some cases, a soft rank metric (e.g., the metric used to determine the soft rank) may be a tunable function. For example, the function may be tuned in accordance with one or more indicated sets of parameters. For example, in accordance with a Schur-concave function with tunable parameters p, the soft rank

$$sR ( H ) = exp ( - {\sum }_{n = 1}^{Q} {s}_{n} log ( {s}_{n} ) ) , where , {s}_{n} = \frac{{σ}_{n}^{2 p}}{{\sum }_{k = 1}^{Q} {σ}_{k}^{2 p}} ∀ n for any p \geq 1.$$

In some examples, the soft rank metric can be computed using a non-zero eigenvalue of a correlation matrix R=H*H or R=HH*, whichever is smaller. In some cases, the UE may be configured to determine an average correlation matrix over one or more indicated or configured channel measurements and/or channel measurement resources (CMRs). In some examples, the Schur-concave soft rank metric function may have a larger value, when evaluated using two different vectors of singular values, for the vector having the entries with a lesser or smaller spread therebetween and/or for the vector having more similar entries.

In some examples, the soft rank may be determined according to a channel estimate (e.g., a channel measurement). For example, in a MIMO channel H, with M outputs and N inputs with M≤N,

$$sR ( H ) = {\sum }_{r = 1}^{M} {rw}_{r} ,$$

where wᵣ is a non-negative weight associated with rank r. The set of weights are non-negative and normalized so that

$${\sum }_{r = 1}^{M} {w}_{r} = 1 , {w}_{r} \geq 0.$$

For each rank r, a representative precoder of rank r, Fᵣ, may be selected from, for example, a port-selection codebook (e.g., each codeword of such a codebook may correspond to a specific selection of the transmit ports). Choice of a port selection codebook and selection of a representative precoder may reduce or avoid complexity associated with a precoder search within a dense codebook (e.g., an over-sampled codebook of discrete Fourier transform (DFT) vectors). In some examples, wᵣ may be an output obtained using a function that increases as the precoded channel correlation, (HFᵣ)*HFᵣ, becomes more diagonally dominant or closer to an orthogonal matrix, and also increases as a Frobenius norm of precoded channel, HFᵣ, increases.

In another example of a soft rank metric for a MIMO channel between a UE and a network entity, the soft rank may be determined using a metric associated with the channel estimates as well as transmit power and Rₙₙ measurements or indications. For example, a MIMO channel can be whitened using an Rₙₙ estimate,

$$\tilde{H} = {R}_{nn}^{- 1 / 2} H ,$$

with M outputs and N inputs characterizing the MIMO channel. The non-zero singular values of the MIMO channel can be {σ₁, . . . , σ_{Q}}, for any 1≤Q≤min(M, N). A soft rank of \tilde{H} determined using the metric is not restricted to be an integer, and may comprise an integer value or a non-integer values. For example, the soft rank \tilde{H} may be a continuous value in interval [1,Q]. In some cases, an example soft rank metric may be

$${\sum }_{r = 1}^{Q} {rw}_{r} ,$$

where wᵣ is a normalized and non-negative weight associated with rank r. In some cases, wᵣ may be a ratio of an estimated spectral efficiency (SE) of the UE when using the rank r (e.g., denoted by SEᵣ) to the sum of the estimated SE achieved across all ranks

$$( e . g . , {w}_{r} = \frac{{SE}_{r}}{{\sum }_{k = 1}^{Q} {SE}_{k}} ) .$$

To determine the SE, the network entity may indicate or point to a technique by which the UE may determine the SE for each rank. In some cases, the UE may indicate available techniques for SE determination per rank to the network entity in a capability report. In some examples, the technique for determining the SE may be based on a CQI report provided to or computed by the UE for each rank. The ranks, and the precoders for each rank used in respective CQI computations, may be indicated by the network entity via, for example, one or more codebook subset restrictions. In some examples, such as for operations that do not involve precoder search but involve a singular value or eigen decomposition, operations for determining or measuring the soft rank metric may be based, at least in part, on a geometric mean decomposition under which the SE for each rank r (e.g., denoted by SEᵣ) may be determined as

$${SE}_{r} = log ( 1 + \frac{ρ}{r} {\prod }_{i = 1}^{r} ( {σ}_{i}^{2 / r} ) ) ,$$

1≤r≤Q or a singular value decomposition (SVD)-based approach under which

$${SE}_{r} = {\sum }_{i = 1}^{r} log ( 1 + \frac{ρ}{r} {σ}_{i}^{2} ) .$$

In both cases, the term p may represent a transmit power. In some cases, the example SVD-based soft rank metric above may be used corresponding to relatively stable channel and/or noise scenarios, and the example geometric mean decomposition-based metric above may be used corresponding to relatively less stable channel and/or noise scenarios (e.g., including scenarios where increased robustness relative to the example SVD-based metric is needed or beneficial, etc., and/or when increased evenness of quality across layers relative to the SVD-based metric is needed or beneficial, etc.)

In some examples of a soft rank metric for a MIMO channel between a UE and a network entity, the UE may transmit, and the network entity may receive, a soft rank report that includes the soft rank for the serving cell or the candidate cell. In some cases, the UE may transmit a dominant set report with or separate from the soft rank report. The dominant set report may indicate a cardinality of a dominant singular value set. In some cases, the soft rank report, the dominant set report, or a combination thereof, among other examples, may be transmitted via UCI or Layer 2/Layer 3 messaging. In another example of a soft rank metric for a MIMO channel between a UE and a network entity, the network entity may transmit, and the UE may receive, a parameter update or metric update. In some cases, the parameter update or metric update may be transmitted to the UE via RRC messaging, a MAC-CE, or DCI. In some cases, the parameter update or metric update may include a soft rank range update (e.g., an update to a range of the soft rank). Alternatively or in addition, the parameter update or metric update may include a step size update (e.g., an update to a step size between possible soft ranks). In some examples, the one or more parameters of the soft rank configuration may be associated with an uplink channel.

In some cases, the UE may transmit, and the network entity may receive, a capability report that includes information regarding a soft rank computation or estimation capability of the UE for a future channel condition. For example, the capability report may indicate an achievable mean squared error for predicting a future channel condition or a confidence measure in estimating the soft rank based on the predicted future channel condition for different values of time offsets or for different scenarios experienced by the UE (such as rate of channel variations, channel delay spreads, or a combination thereof, among other examples). In some cases, the network entity may set the time offset configuration in accordance with the information regarding one or more capabilities of the UE. In some cases, the network entity may obtain, from the UE report, the estimated soft rank for the future channel condition along with an associated confidence measure.

As noted above, systems and techniques are described herein that can be used to provide soft rank prediction and/or soft rank prediction and reporting for a MIMO channel associated with a UE and a network entity (e.g., base station, gNB, etc.). In some examples, the systems and techniques can be used to provide soft rank prediction and reporting of one or more soft rank predictions associated with the MIMO channel, based at least in part on configuration information transmitted by the network entity and received by the UE, where the configuration information corresponds to one or more configurations, metrics, parameters, etc., for the soft rank prediction performed by the UE. In some cases, soft rank prediction can be implemented based on and/or corresponding to one or more of a CSI prediction framework and/or techniques for UE-side CSI prediction.

For example, soft rank prediction may be included in and/or associated with one or more CSI feedback enhancement techniques, including CSI feedback techniques implemented based on time-domain CSI prediction using one or more machine learning (ML) and/or artificial intelligence (AI) models configured as UE-side models (e.g., ML and/or AI models implemented by the UE, etc.). In some cases, a soft rank prediction can be generated as an inference output (e.g., prediction output, etc.) determined using one or more ML or AI models running on the UE. For example, a UE may use one or more ML or AI models trained and/or configured for soft rank prediction to determine soft rank prediction information and/or to determine one or more predicted soft rank values for a configured set of one or more resources associated with a MIMO channel, etc. In some examples, UE-side ML or AI models for soft rank prediction can be configured, implemented, updated, maintained, etc., according to an AI/ML model framework implemented for the wireless communication network including the UE and one or more network entities (e.g., base station, gNB, etc.). For example, model generation and/or model training (e.g., including input/output, pre-/post-processing, online/offline configurations, etc.), model validation, and/or model testing, etc., may be implemented and/or performed according to the AI/ML model framework of the wireless communication network. In some cases, inference operation(s), including input/output and/or pre-post-processing, etc., and including UE-side soft rank prediction based on AI/ML model inference to determine soft rank prediction information and/or predicted soft rank values, may be implemented according to the AI/ML model framework of the wireless communication network.

The AI/ML model framework of the wireless communication network can be configured for different, various levels of collaboration between UEs and network entities for various use cases of AI/ML models for inference and/or other prediction(s). In some cases, an AI/ML model associated with the AI/ML model framework of the wireless communication network can be implemented without collaboration between the UE and the network entity (e.g., such as an implementation-based only AI/ML model or algorithm, configured for operation without information exchange between UEs and network entities, etc.). Various other levels of UE and network entity (e.g., base station, gNB, etc.) AI/ML model and/or algorithm collaboration may also be used, including various levels of collaboration corresponding to separate AI/ML operations implemented by the UE (e.g., separate UE-side AI/ML model inference, etc.), and/or including various levels of collaboration corresponding to joint AI/ML operations between the UE and the network entity. Lifecycle management of AI/ML models (e.g., such as and/or including one or more soft rank prediction AI/ML models, etc.) can be implemented or performed according to the AI/ML model framework of the wireless communication network. Lifecycle management of AI/ML models can include model training, model deployment, model inference, model monitoring, model updating, etc. The dataset(s) for training, validation, testing, and/or inference for one or more AI/ML models (e.g., such as and/or including one or more soft rank prediction AI/ML models, etc.) can be determined based at least in part according to the AI/ML model framework associated with the wireless communication network.

The systems and techniques provided herein can be used for soft rank prediction and/or reporting of soft rank prediction information, for example from a UE to a network entity (e.g., base station, gNB, etc.). As noted above, soft rank values can be used for improved granularity assessments and analyses of underlying channel and interference conditions for a MIMO channel between the UE and network entity. Soft rank reporting, including the reporting of predicted soft rank values, can be used by a network entity to determine rank transitions for future times, based at least in part on receiving from the UE one or more predicted soft rank values corresponding to time-frequency resources at the future times. Soft rank prediction and reporting can correspond to faster and more efficient adaptation and/or adjustment by a network entity to varying channel conditions, based on the varying channel conditions causing corresponding change(s) in the soft rank prediction(s) determined and reported from the UE to the network entity. In some cases, soft rank prediction by a UE can be used to implement energy savings for the UE.

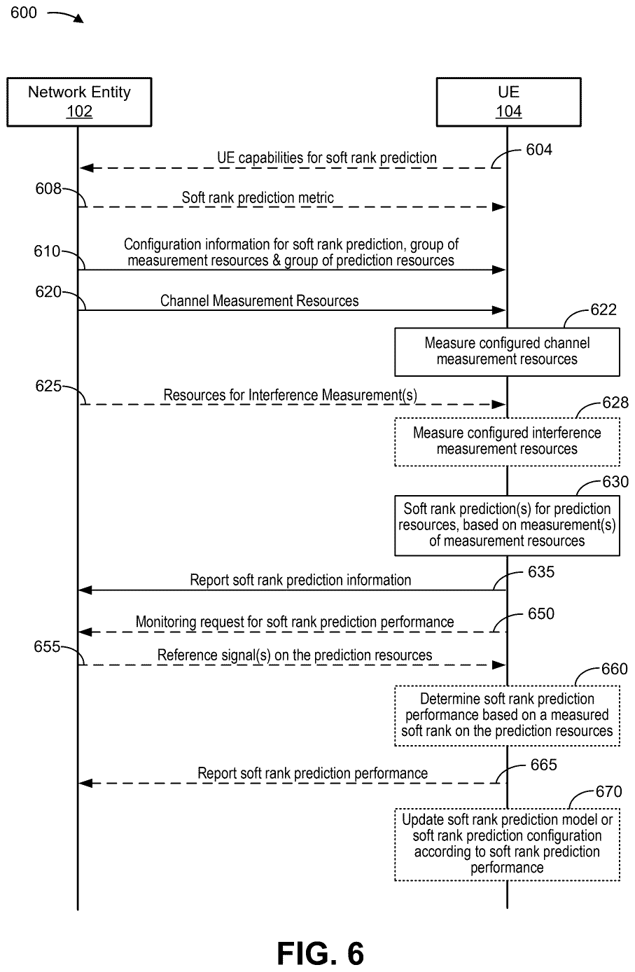

FIG. 6 is a call flow diagram illustrating an example of signaling 600 between a network entity 102 (e.g., base station, gNB, network node, etc.) and a UE 104 (e.g., and/or other network device, etc.), where the signaling 600 is associated with soft rank prediction and/or soft rank prediction and reporting by the UE 104. For example, the soft rank prediction and/or reporting can correspond to soft rank values predicted for a MIMO channel associated with the UE 104 and the network entity 102. Soft rank prediction can be performed by the UE 104, based at least in part on configuration information 610 transmitted by the network entity 102, and received by the UE 104. For example, the configuration information 610 can be indicative of one or more parameters, metrics, conditions, thresholds, etc., corresponding to an implementation of soft rank prediction and/or soft rank prediction reporting (e.g., reporting of predicted soft rank information and/or predicted soft rank values) by the UE.

In some cases, the configuration information 610 can indicate one or more configurations for the soft rank prediction performed by the UE 104. For example, soft rank prediction can be performed based on channel prediction information determined by the UE 104, channel prediction information and interference prediction information determined by the UE 104, channel measurement information and interference prediction information determined by the UE 104, channel prediction information and interference measurement information determined by the UE 104, etc. The configuration information 610 can indicate an input configuration corresponding to the soft rank prediction by the UE 104, where the input configuration indicates a particular combination of at least one of channel measurement information, channel prediction information, interference measurement information, and/or interference prediction information to be determined by the UE 104 and used for the soft rank prediction(s) configured by the configuration information 610.

In some examples, the configuration information 610 can be determined by the network entity 102, and may be based at least in part on one or more UE capabilities for soft rank prediction. For example, the UE 104 can transmit or report UE capability information 604 indicative of one or more UE capabilities for soft rank prediction. The UE capability information 604 can indicate the capability, or lack of capability, by the UE to perform soft rank prediction for one or more configurations of the soft rank prediction. For example, the soft rank prediction UE capability information 604 can indicate a capability of the UE 104 to support soft rank prediction, or a lack of a capability to support soft rank prediction. In some cases, the network entity 102 can transmit the configuration information 610 for soft rank prediction based on the UE capabilities 604 including an indication of the UE 104 capability to support soft rank prediction.

In some cases, the soft rank prediction UE capability information 604 can include an indication of the capability for UE 104 to support various input configurations of soft rank prediction. For example, the soft rank prediction UE capability information 604 can indicate whether the UE 104 supports soft rank prediction based on channel prediction information only, whether the UE 104 supports soft rank prediction based on interference prediction information only, whether the UE 104 supports soft rank prediction based on various combinations of channel prediction, channel measurement, interference prediction, and/or interference measurement, etc. In some examples, the soft rank prediction UE capability information 604 can indicate a capability of the UE 104 to support one or more soft rank prediction metrics. For example, the soft rank prediction UE capability information 604 can indicate a subset of soft rank prediction metrics supported by the UE 104, where the supported subset of soft rank prediction metrics is included in a plurality of configured soft rank prediction metrics. In some cases, the soft rank prediction UE capability information 604 can explicitly indicate support or a lack of support for each respective soft rank prediction metric of the plurality of configured soft rank prediction metrics. In some examples, the soft rank prediction UE capability information 604 can include an explicit indication of support for each supported soft rank prediction metric of the plurality of configured soft rank prediction metrics, and may implicitly indicate a lack of support for each non-supported soft rank prediction metric of the plurality of configured soft rank prediction metrics.

In some aspects, the soft rank prediction UE capability information 604 can be indicative of a maximum time duration capability of the UE 104 (e.g., a maximum time duration for soft rank prediction supported by the UE 104, etc.). The soft rank prediction UE capability information 604 may include an indication of the UE 104 capability for maximum beam separation and/or maximum frequency separation supported by the UE 104 for the soft rank prediction. In some cases, the soft rank prediction UE capability information 604 can include an indication of the maximum number of beams and/or sub-bands (e.g., component carriers (CCs)) supported by the UE 104 capability for the soft rank prediction.

In some aspects, the network entity 102 can receive the soft rank prediction UE capability information 604, and can determine a soft rank prediction metric 608 that is within the capabilities of the UE 104. For example, the network entity 102 can determine and signal the soft rank prediction metric 608 to the UE 104, where the soft rank prediction metric 608 is determined from a plurality of configured soft rank prediction metrics (e.g., a plurality of candidate soft rank prediction metrics, and/or a plurality of soft rank prediction metrics supported by the network entity 102 that may or may not be supported by or within the UE capabilities 604 of the UE 104, etc.). The soft rank prediction metric 608 can be a selected soft rank prediction metric determined from a plurality of candidate soft rank prediction metrics based on the UE capabilities 604 for soft rank prediction.

For example, the soft rank prediction metric 608 can be used to implement soft rank prediction by the UE 104, where the UE 104 performs the soft rank prediction to determine one or more predicted soft rank values for resources (e.g., a subset of resources indicated by the configuration information 610, etc.) of a MIMO channel with M outputs and N inputs. In an illustrative example, the soft rank prediction metric 608 can correspond to soft rank prediction values that can be any non-negative value that does not exceed (e.g., is less than or equal to) min(M, N). The M outputs and N inputs of the MIMO channel can correspond to M, N antenna dimensions at the transmitter and receiver, respectively.

In another example, the soft rank prediction metric 608 can correspond to soft rank values determined by the UE 104 where the soft rank value is divided into configured (e.g., according to the soft rank prediction metric 608 and/or the configuration information 610, etc.) non-integer only intervals (e.g., 1, 1.2, 1.3, . . . , Q=min(M, N)). In some aspects, the soft rank values can be determined by the UE 104 as a selection of a particular soft rank value from a plurality of configured (e.g., candidate) soft rank values included a codebook of soft rank values. For example, the network entity 102 can determine and/or indicate to the UE 104 a configured codebook of soft rank values to be used for the soft rank prediction. Based on the configured codebook of soft rank values, the UE 104 can perform the soft rank prediction to use only soft rank values that are included in the configured codebook. The configured codebook can be signaled by the network entity 102 via the soft rank prediction metric 608 and/or the configuration information 610.

In some aspects, the UE 104 can receive the configuration information 610 for soft rank prediction, without previously transmitting the UE capabilities 604 for soft rank prediction to the network entity 102, and/or without previously receiving the indication of the soft rank prediction metric 608 selected or configured by the network entity 102 for the UE 104 soft rank prediction. The configuration information 610 can also be referred to as a soft rank prediction configuration information and/or a soft rank prediction configuration.

In some aspects, the configuration information 610 be indicative of at least a first set of resources and a second set of resources, where the first and second sets of resources are included in the MIMO channel. For example, the first set of resources can comprise a set of measurement resources (e.g., also referred to as a group of measurement resources) configured by the network entity 102 for the soft rank prediction by the UE 104. The second set of resources can comprise a set of prediction resources (e.g., also referred to as a group of prediction resources) configured by the network entity 102 for the soft rank prediction by the UE 104. In an illustrative example, the first and second sets of resources (e.g., the group of measurement resources and the group of prediction resources) can each comprise a respective plurality of channel measurement resources. For example, the group of measurement resources and the group of prediction resources can include one or more resources corresponding to one or more SSBs, CSI-RSs, etc.

The group of measurement resources and the group of prediction resources indicated by the configuration information 610 can comprise time-frequency resources of the MIMO channel. In some aspects, the measurement and prediction resources indicated by the configuration information 610 and used by the UE 104 for the soft rank prediction can vary in time (e.g., different time resources mapped to and/or included within the group of measurement resources and the group of prediction resources). The measurement and prediction resources indicated by the configuration information 610 and used by the UE 104 for the soft rank prediction can vary in frequency (e.g., different frequency resources, sub-channels, CCs, BWPs, etc., of the MIMO channel mapped to and/or included within the group of measurement resources and the group of prediction resources). The measurement and prediction resources indicated by the configuration information 610 and used by the UE 104 for the soft rank prediction can vary in space (e.g., can vary spatially, based on different respective beams, spatial layers, spatial streams, etc., of the MIMO channel being mapped to and/or included within the group of measurement resources and the group of prediction resources). In some aspects, the measurement and prediction resources indicated by the configuration information 610 and used by the UE 104 for the soft rank prediction can vary in one or more of time, frequency, and space.

In some examples, the measurement resources and/or the prediction resources indicated by the configuration information 610 can be periodic resources, semi-periodic resources, semi-persistent resources, and/or aperiodic resources associated with the MIMO channel. In some aspects, the measurement resources and/or the prediction resources can comprise different respective configurations or sub-configurations in the spatial domain for the same set of CSI-RS, SSB, and/or CSI-IM resources. For example, the configuration information 610 can be indicative of a plurality of CSI-RS, SSB, and/or CSI-IM resources. The configuration information 610 can be indicative of a first spatial domain sub-configuration of the plurality of CSI-RS, SSB, and/or CSI-IM resources, where the group of measurement resources (e.g., channel measurement resources 620 and/or interference measurement resources 625, etc.) corresponds to the plurality of CSI-RS, SSB, and/or CSI-IM resources with the first spatial domain sub-configuration applied.

The configuration information 610 can be indicative of a second spatial domain sub-configuration of the plurality of CSI-RS, SSB, and/or CSI-IM resources, where the second spatial domain sub-configuration is different from the first spatial domain-sub-configuration. The group of prediction resources for the soft rank prediction(s) 630 by the UE 104 can correspond to the plurality of CSI-RS, SSB, and/or CSI-IM resources with the second spatial domain sub-configuration applied.

In some aspects, the first and second spatial domain sub-configurations for the measurement and prediction resources (respectively) can be implemented as respective spatial domain sub-configurations to disable or enable all antenna elements associated to a logical antenna port of the UE 104. For example, the first and second spatial domain sub-configurations can enable and/or disable all respective antenna elements of different respective combinations of the respective antenna elements associated to each logical antenna port of one or more logical antenna ports of the UE 104. In another illustrative example, the first and second spatial domain sub-configurations for the measurement and prediction resources (respectively) can be implemented as respective spatial domain sub-configurations that enable or disable different respective subsets of antenna elements associated with each logical antenna port of one or more logical antenna ports of the UE 104. For example, measurement resources can be configured according to a first spatial domain sub-configuration causing the UE 104 to obtain the channel measurement information 622 and/or interference measurement information 628 based on a 4×4 subarray of antenna elements of a 16×16 array of antenna elements for a logical antenna port of the UE 104, and prediction resources can be configured according to a second spatial domain sub-configuration causing the UE 104 to determine the soft rank prediction information and/or one or more predicted soft rank values for the entire 16×16 array of antenna elements of the logical antenna port of the UE 104. IN another illustrative example, the measurement resources can correspond to the UE 104 using a first 4×4 subarray of antenna elements of the 16×16 array of the logical antenna port, and the prediction resources can correspond to the UE 104 using a different, second 4×4 subarray of antenna elements of the 16×16 array of the logical antenna port, and/or using an 8×8 subarray of antenna elements of the 16×16 array of the logical antenna port, etc.

In some aspects, the measurement and prediction resources configured by the network entity 102 via the configuration information 610, and used by the UE 104 for the soft rank prediction(s) 630 can correspond to respective sets of measurement and prediction resources included within a single physical transmit receive point (TRP), or respective sets of measurement and prediction resources included within multiple different TRPs. For example, channel measurements for one TRP can be used by the UE 104 for soft rank prediction for another TRP. In an illustrative example, the configuration information 610 can cause the UE 104 to determine channel measurement information 622 for a set of channel measurement resources 620 associated with a first TRP (e.g., a channel observed by the UE 104 from the first TRP), and can cause the UE 104 to determine the soft rank prediction(s) 630 for a set of prediction resources associated with a second TRP (e.g., a channel observed by the UE 104 from the second TRP). In some aspects, the prediction of soft rank information for a second TRP based on measurements of a channel for a first TRP can be implemented to optionally use a reduced set of measurement resources from the second TRP.

The configuration information 610 can correspond to soft rank prediction performed by the UE 104, based on the UE 104 being configured to measure the group of measurement resources to predict a soft rank on the group of prediction resources. The UE 104 can perform soft rank reporting to report, to the network entity 102, soft rank prediction information 635 corresponding to and/or indicative of one or more predicted soft rank values for the prediction resources. For example, the UE 104 can determine a soft rank prediction 630 including one or more predicted soft rank values for a set of resources comprising the group of prediction resources indicated by the configuration information 610 received from the network entity 102. The UE 104 can transmit signaling indicative of the soft rank prediction information to the network entity, for example based on the UHE 104 determining the soft rank prediction(s) 630 for the prediction resources based on at least the measurements 622 of configured channel measurement resources 620 indicated by the configuration information 610 and transmitted by the network entity 102 as the channel measurement resources 620 (e.g., one or more reference signals, SSBs, CSI-RS, and/or other RSs transmitted by the network entity 102 using the configured measurements resources indicated by the configuration information 610).

The configuration information 610 can be received from the network entity 102, and can comprise configuration information associated with soft rank prediction by the UE 102. The configuration information 610 can be indicative of at least a first set of resources and a second set of resources. For example, the first set of resources can be a first set or group of channel measurement resources 620, such as synchronization signal blocks (SSBs), CSI-reference signals (CSI-RSs), etc. The second set of resources can be a second set or group of channel measurement resources. In some cases, the first set of resources can be configured as measurement resources (e.g., channel measurement resources 620) associated with and used by the UE 102 for the soft rank prediction. The second set of resources can be configured as prediction resources associated with and used by the UE 102 for the soft rank prediction. For example, the UE 102 can be configured to measure the channel and/or interference on the group of measurement resources 620 (e.g., the first set of resources indicated by the configuration information 610), and to predict the soft rank value(s) corresponding to the soft rank prediction(s) 630 on the group of prediction resources (e.g., the second set of resources indicated by the configuration information 610). The UE 102 can transmit a soft rank prediction report 635 to the network entity 102, where the soft rank prediction report 635 is indicative of soft rank prediction information including at least the predicted soft rank value(s) 630 on the group of prediction resources, and/or subsets thereof.

In some cases, the first set of resources indicated by the configuration information 610 can comprise a plurality of channel measurement resources associated with the MIMO channel between the UE 104 and the network entity 102, and the second set of resources can comprise a plurality of prediction resources associated with the same MIMO channel. The first and second sets of resources (e.g., measurement and prediction resources, respectively) can vary in one or more of time, frequency (e.g., sub-channels, component carriers (CCs), and/or bandwidth parts (BWPs), etc.), and/or space (e.g., beams, spatial layer or streams, etc.), as noted above. In some examples, the UE 104 can perform the soft rank prediction 630 according to one or more soft rank prediction metrics 608 and/or configurations indicated by the network entity 102 using the configuration information 610. For example, the soft rank prediction 630 can be based on channel prediction only, channel prediction and interference prediction, channel measurement and interference prediction, channel prediction and interference measurement, etc. In some cases, the UE 104 can determine one or more predicted soft rank values 630 corresponding to one or more resources of the second set of resources (e.g., prediction resources).

The predicted soft rank values 630 may be reported from the UE 104 to the network entity 102 via signaling indicative of the soft rank prediction information including the one or more predicted soft rank values (e.g., the report 635 of the soft rank prediction information determined by the UE 104). In some cases, the predicted soft rank values 630 can be reported from the UE 104 to the network entity 102 using a CSI report, where the CSI report is extended to include the predicted soft rank values 630 and/or other soft rank prediction information. For example, the soft rank prediction report 635 can comprise a CSI report and/or can be included within a CSI report, etc. In some cases, the predicted soft rank values 630 can be transmitted from the UE 104 to the network entity 102 via signaling (e.g., the soft rank prediction report 635) combining the soft rank prediction information with various other measured and/or predicted CSI values or information, etc. (e.g., as the soft rank prediction report 635).

In an illustrative example, the configuration information 610 is indicative of a group of measurement resources corresponding to the channel measurement resources 620. The group of measurement resources indicated in the configuration information 610 and transmitted by the network entity 102 corresponding to the channel measurement resources 620 can comprise one or multiple sets (e.g., subsets) of measurement resources for the soft rank prediction 630 by the UE 104. For example, the channel measurement resources 620 can comprise one group of channel measurement resources (e.g., SSB, CSI-RS, etc.), and the UE 104 can be configured to determine respective channel measurement information 622 based on measuring the channel on the group of channel measurement resources 620. In some aspects, the channel measurement information 622 can comprise channel measurement values of one or more of the channel measurement resources 620, can comprise channel prediction values predicted for one or more of the channel measurement resources 620 (e.g., based on and/or using one or more of the channel measurement values, etc.), and/or can comprise various combinations of channel measurement values and channel prediction values for one or more of the channel measurement resources 620.

In some cases, the UE 104 may additionally be configured (e.g., based on the configuration information 610, etc.) to measure or predict interference information 628 on at least a portion of the group of channel measurement resources 620 configured by the network entity 102 in the soft rank prediction configuration information 610. In some cases, the channel measurement resources 620 can comprise a first subset of measurement resources and a second subset of measurement resources, where the first subset of measurement resources includes channel measurement resources (e.g., SSB, CSI-RS, etc.) and the second subset of measurement resources includes inter-cell interference measurement resources (e.g., CSI interference measurement (CSI-IM), etc.).

The channel measurement information 622 can be determined based on the UE 104 measuring the channel to determine channel measurements corresponding to the first subset of measurement resources included in the channel measurement resources 620, and based on the UE 104 measuring the interference (e.g., inter-cell interference) on the CSI-IM or other interference measurement resources of the second subset of measurement resources included in the channel measurement resources 620. The channel measurement information 622 can include channel measurements of the first subset of resources of the channel measurement resources 620, and can include interference measurements (e.g., inter-cell interference measurements) on the second subset of CSI-IM or other interference measurement resources of the channel measurement resources 620.

In some aspects, the configuration information 610 can indicate the set of channel measurement resources 620, and can indicate one or more resources for interference measurement(s) 625 (e.g., also referred to as interference measurement resources 625). The interference measurement resources 625 can comprise resources for measuring interference such as inter-cell interference by the UE 104. For example, the interference measurement resources 625 can include one or more CSI-IM resources used by the UE 104 to determine interference measurement information 628.

In some cases, the group of measurement resources indicated by the configuration information 610 can include an indication of a first subset of measurement resources comprising the channel measurement resources 620, which can be measured by the UE 104 to determine the channel measurement information 622. In some cases, the interference measurement information 628 can be determined based on measuring interference for one or more resources included in the channel measurement resources 620. In some examples, the group of measurement resources indicated by the configuration information 610 includes an indication of a separate, second subset of measurement resources comprising the interference measurement resources 625, which can be measured by the UE 104 to determine the interference measurement information 628 (e.g., inter-cell interference measurements based on one or more CSI-IM resources included in the interference measurement resources 625, etc.).

In some aspects, the group of measurement resources indicated by the configuration information 610 can include an indication of a third subset of measurement resources, where the third subset of measurement resources comprises resources for MU-MIMO interference measurement(s). For example, the third subset of MU-MIMO interference measurement resources can include non-zero-power (NZP) CSI-RS resources, CSI-IM resources, etc. The UE 104 can be configured to measure the MU-MIMO interference on the third set of resources to determine MU-MIMO interference information. In some aspects, the third subset of MU-MIMO interference measurement resources (e.g., NZP CSI-RS, CSI-IM, etc.) can be included in the resources for interference measurement(s) 625. In some examples, the third subset of MU-MIMO interference measurement resources (e.g., NZP CSI-RS, CSI-IM, etc.) can be transmitted from the network entity 102 separately from the interference measurement resources 625.

In some aspects, the configuration information 610 is indicative of a second set of resources configured as a group of prediction resources, as noted above. For example, the second set of resources can be prediction resources corresponding to the soft rank prediction 630 by the UE 104. In some aspects, the group of prediction resources can comprise one or more subsets of prediction resources. For example, the group of prediction resources can comprise a single subset (e.g., where the single subset is the same as the group of prediction resources) of prediction resources, which the UE 104 can be configured to use to perform the soft rank prediction(s) 630 for the prediction resources, based on measurements of the measurement resources (e.g., based on the channel measurement information 622 and/or the interference measurement information 628). The soft rank prediction information included in the soft rank prediction report 635 generated and transmitted by the UE 104 to the network entity 102 can correspond to the group of prediction resources indicated by the configuration information 610.

In some cases, the soft rank prediction(s) 630 and/or report 635 of soft rank prediction information can correspond to soft rank prediction information determined for the prediction resources by the UE 104, based on the channel measurement information 622 and/or interference measurement information 628 determined by the UE 104 for the measurement resources (e.g., channel measurement resources 620 and/or interference measurement resources 625).

In some aspects, the soft rank prediction(s) 630 and/or report 635 of soft rank prediction information can be based on the configuration information 610 and/or soft rank prediction metric 608 causing the UE 104 to predict the channel on the group of prediction resources, and perform soft rank prediction 630 to determine the soft rank prediction information and/or one or more predicted soft rank values for the prediction resources using the predicted channel information.

In some aspects, the soft rank prediction(s) 630 and/or report 635 of soft rank prediction information can be based on the configuration information 610 and/or soft rank prediction metric 608 causing the UE 104 to predict the channel and to predict the interference on the group of prediction resources. The UE 104 can perform soft rank prediction 630 to determine the soft rank prediction information and/or one or more predicted soft rank values for the prediction resources using a combination of the predicted channel and the predicted interference on the group of prediction resources. In some examples, the UE 104 can predict the channel and can predict the interference for the same one or more prediction resources. In some aspects, the UE 104 can predict the channel for a first subset of the prediction resources, and can predict the interference for a second subset of the prediction resources. For example, in some cases, the group of prediction resources includes a first and second subset of prediction resources, and the UE 104 can be configured to determine channel prediction information corresponding to the first subset of prediction resources and to determine inter-cell interference predictions corresponding to the second subset of prediction resources. The UE 104 can determine, and report to the network entity 102 via the report 635 of soft rank prediction information, a predicted soft rank information determined based on the channel prediction(s) on the first subset of prediction resources and then inter-cell interference prediction(s) on the second subset of prediction resources.

In some cases, the group of prediction resources can include a third subset of prediction resources, and the UE 104 can be configured to use the third subset of prediction resources for MU-MIMO interference prediction(s), and the soft rank prediction information can be determined using the MU-MIMO interference prediction(s). For example, the UE 104 can perform soft rank prediction 630 to determine the soft rank prediction information and/or one or more predicted soft rank values for the prediction resources using a combination of the predicted channel determined for the first subset of prediction resources, the predicted inter-cell interference determined for the second subset of prediction resources, and the predicted MU-MIMO interference determined for the third subset of prediction resources. In some aspects, the configuration information 610 can be indicative of the plurality of prediction resources included in the group of prediction resources, and can be indicative of the respective subsets of prediction resources of the plurality of prediction resources mapped to each of the respective first, second, and/or third subsets of prediction resources noted above.

In some aspects, the report 635 of the soft rank prediction information correspond to the soft rank prediction(s) 630 of the UE 104 can be reported as a respective soft rank prediction information and/or a respective predicted soft rank value per group of resource elements (REs) of a plurality of groups of REs included within and/or configured for the plurality of prediction resources indicated by the configuration information 610. For example, the UE 104 can transmit the report 635 of soft rank prediction information based on the UE 104 reporting a vector of soft ranks correspond to the different RE groups of the configured plurality of prediction resources. In some cases, the vector of soft ranks used for the report 635 of soft rank prediction information can comprise a vector of soft rank values including a respective soft rank value or entry for each sub-band of a plurality of sub-bands associated with the group of prediction resources, for each precoding resource group (PRG) of one or more PRGs associated with the group of prediction resources, and/or for each resource block group (RBG) of one or more RBGs associated with the group of prediction resources, etc. In some examples, soft rank grouping per sub-band can be configured by the network entity 102, for example using the configuration information 610. In some cases, soft rank grouping for the report 635 of soft rank prediction information can be configured according to one or more pre-determined or pre-defined rules for soft rank prediction reporting, for example indicated by a wireless standard used for the wireless communication network including the UE 104 and the network entity 102. In some cases, the soft rank grouping to be used for the report 635 of soft rank prediction information by the UE 104 can be based at least in part on a UE recommendation of a soft rank prediction configuration, where the UE 104 transmit information indicative of the UE recommendation for configuring the soft rank prediction to the network entity 102, and the network entity 102 can determine the configuration information 610 based at least in part on the UE recommended configuration.

In some aspects, the soft rank prediction metric 608 and/or configuration information 610 can cause the UE 104 to perform the soft rank prediction to determine the soft rank prediction(s) 630 using an input configuration of channel components only. For example, the soft rank prediction metric 608 can be a predicted soft rank determined using channel component information only, where the channel component information comprises the channel measurements 622 for the channel measurement resources 620 and does not include the interference measurements 628 for the interference measurement resources 625. For example, a soft rank metric 608 for soft rank prediction(s) 630 using channel components only can correspond to the UE 104 determining the soft rank prediction(s) 630 as any function of the channel component (e.g., channel measurement information 622) singular values of H*H or HH* for the MIMO channel H. In some cases, the UE 104 can be configured to determine the soft rank prediction(s) 630 based on predicting the channel component singular values comprising a non-zero eigenvalue of a correlation matrix R=H*H or R=HH*, using the dimensionally smaller of the two matrices R=H*H or R=HH*. The soft rank prediction(s) 630 can be determined as a function of the metric predicting the singular values of the correlation matrix R=H*H or R=HH*.

For example, for a MIMO channel H with M outputs and N inputs, and with the non-zero singular values of H*H or HH* represented as {σ₁, . . . , σ_{Q}} for a rank Q, the soft rank prediction(s) 630 can be determined by the UE 104 as the soft rank predicted values:

$$SR ( H ) = exp ( - {\sum }_{n = 1}^{Q} {s}_{n} log ( {s}_{n} ) ) , where , {s}_{n} = \frac{{σ}_{n}^{2 p}}{{\sum }_{k = 1}^{Q} {σ}_{k}^{2 p}} ∀ n \qquad Eq . ( 1 )$$

Here, {σ₁, . . . , σQ} are the non-zero singular values of H*H or HH*, and p is a tunable parameter subject to the condition of p≥1 for the tunable parameter. In some aspects, the soft rank predicted value(s) 630 (e.g., SR(H) of Eq. (1), etc.) can be a lower bound true rank.

In some cases, the soft rank predicted value(s) 630 (e.g., SR(H) of Eq. (1), etc.) can be configured to have a value that does not exceed a value of the rank Q. In some aspects, the soft rank value predicted by the UE 104 (e.g., the soft rank predicted value(s) 630, etc.) may be scale invariant, and/or the soft rank prediction metric 608 may be scale invariant. For example, when the soft rank prediction metric 608 and/or soft rank prediction(s) 630 are scale invariant, the two MIMO channels H and γH will have the same soft rank prediction for any scaling factor γ>0. In some aspects, the soft rank predicted value(s) 630 (e.g., SR(H) of Eq. (1), etc.) and/or the soft rank prediction metric 608 may be a Schur-concave function of one or more singular values σ.

In some aspects, the soft rank prediction can be implemented based on channel components and interference components. For example, the soft rank prediction(s) 630 can be based on channel measurement information 622 and interference measurement information 628, as noted above. In some aspects, the UE 104 can be configured to whiten the channel (e.g., MIMO channel between the UE 104 and network entity 102, etc.) using a measured or predicted interference-plus-noise covariance matrix (Ran) according to:

$$\tilde{H} = {R}_{nn}^{- 1 / 2} H \qquad Eq . ( 2 )$$

In the example of Eq. (2), \tilde{H} represents the predicted soft rank information or predicted soft rank values. Rₙₙ is the measured or predicted interference-plus-noise covariance matrix, and H is the MIMO channel. In some aspects, the soft rank prediction can be implemented following the channel component-only prediction noted above and described according to Eq. (1), after whitening the channel matrix. In another illustrative example, the soft rank prediction can be determined by the UE 104 according to:

$${\sum }_{r = 1}^{Q} {rw}_{r} \qquad Eq . ( 3 )$$

Here, wᵣ represents the normalized non-negative weight associated with rank r. In some aspects, wᵣ may be a ratio of an estimated spectral efficiency (SE) of the UE 104 when using the rank r (e.g., denoted by SEᵣ) to the sum of the estimated SE achieved across all ranks

$$( e . g . , {w}_{r} = \frac{{SE}_{r}}{{\sum }_{k = 1}^{Q} {SE}_{k}} ) .$$

In some examples, the SE for each rank r (e.g., values of SEᵣ for different ranks r) may be determined based on the geometric mean decomposition (GMD):

$${SE}_{r} = log ( 1 + \frac{ρ}{r} {\prod }_{i = 1}^{r} ( {σ}_{i}^{2 / r} ) ) , 1 \leq r \leq Q \qquad Eq . ( 4 )$$

In another example, the SE for each rank r (e.g., values of SEᵣ for different ranks r) may be determined based on a singular value decomposition (SVD)-based approach:

$${SE}_{r} = {\sum }_{i = 1}^{r} log ( 1 + \frac{ρ}{r} {σ}_{i}^{2} ) \qquad Eq . ( 5 )$$

In some aspects, the UE 104 can be configured to calculate the soft rank prediction metric(s) 608 according to any of Eqs. (1)-(5) and/or various techniques noted above, where the UE 104 determines the soft rank predictions) 630 based on any combination of channel prediction and interference prediction, channel prediction and interference measurements, channel measurement and interference predictions, etc. In some aspects, the UE 104 can be configured to perform interference predictions corresponding to the interference measurement information 628 based on any one or more of the UE 104 predicting a full Rₙₙ matrix, the UE 104 predicting only diagonal elements of the Rₙₙ matrix, and/or the UE 104 predicting only interference power based on predicting the trace of the Rₙₙ matrix, etc. In some aspects, to perform partial Rₙₙ matrix prediction, the UE 104 can be configured to reconstruct the non-predicted elements of the Rₙₙ matrix based on using previously measured values.

In some aspects, the network entity 102 can configure the soft rank prediction by the UE 104 to be based on reuse of a CSI-resource configuration framework and/or a CSI-report configuration framework. For example, the configuration information 610 can include an additional bit or flag in the configured resources of a CSI-resource configuration to indicate the respective group of measurement resources and/or the respective group of prediction resources. In some aspects, the CSI-resource configuration can be indicative of a first subset of one or more resources that are not measurement resources or prediction resources. The first subset of one or more CSI-resource configuration resources may be indicated without the additional bit or flag included. The CSI-resource configuration can be indicative of a second subset of one or more resources that are the group of measurement resources, which can be indicated based on including the additional bit or flag set to a first value for each respective one of the one or more resources being configured as measurement resources for the soft rank prediction by the UE 104. The CSI-resource configuration can be indicative of a third subset of one or more resources that are the group of prediction resources, which can be indicated based on including the additional bit or flag set to a second value for each respective one of the one or more resources being configured as prediction resources for the soft rank prediction by the UE 104. In some aspects, the report 635 can use the CSI-report framework, where the report of soft rank prediction information is based on updated the report quantity information in a CSI report to include one or more predicted soft rank values (e.g., the soft rank prediction(s) 630 determined by the UE 104), with an indication that the soft rank values are predicted soft rank values. A different indication may be used for soft rank values included in the CSI report that are measured soft rank values.

In some aspects, the network entity 102 can configure the UE 104 to determine and report confidence level information associated with the UE prediction of the soft rank values. For example, the configuration information 610 can configure the UE to determine confidence level information associated with the soft rank prediction(s) 630, and to include the determined confidence level information in the report 635 of the soft rank prediction information. In some examples, the configuration information 610 can cause the UE 104 to determine confidence level information as a selected confidence value out of a set of configured confidence values (e.g., {high, medium, low}, etc.). In some cases, the confidence level information for the soft rank prediction(s) 630 can be reported by the UE 104 in the report 635 as a respective confidence level percentage value between [0,100], or a ratio between [0,1] where a value of 1 is mapped to 100% confidence, etc. In some aspects, the soft rank prediction(s) 630 can be determined by one or more AI or ML models implemented by the UE 104 for soft rank prediction, and the reported confidence level information can be confidence value information obtained as an output of a softmax layer of a neural network used for the UE-side AI/ML soft rank prediction model(s). In some cases, the reported confidence level information for the soft rank prediction(s) 630 can be a predicted variance or standard deviation in a soft rank prediction output (e.g., inference output) of the UE-side AI/ML soft rank prediction model(s), etc.

In some aspects, the configuration information 610 can configure the UE 104 to perform performance monitoring associated with the soft rank prediction(s) 630. For example, the network entity 102 can use the configuration information 610 to configure the UE 104 to measure periodic, semi-periodic, and/or aperiodic monitoring channel or interference resources (e.g., CSI-RSs, SSBs, CSI-RSs, etc.) on one or more subsets of the prediction resources, to thereby monitor the soft rank prediction performance and report the prediction performance information to the network entity. For example, the UE 104 may transmit to the network entity 102 a monitoring request 650 for soft rank prediction performance. In some cases, the monitoring request 650 can be a request from the UE 104 to the network entity 102, comprising a request for the network entity 102 to send monitoring resources for the UE 104 to monitor its soft rank prediction performance. In some aspects, the UE 104 can transmit the monitoring request 650 to request a particular one or more channel and/or interference resource(s) to monitor the performance of the soft rank prediction algorithm(s) and/or AI/ML models used by the UE 104 to perform the soft rank prediction(s) 630.

In some aspects, the UE 104 can receive, and the network entity 102 can transmit, reference signal(s) on the prediction resources 655, corresponding to the monitoring request 650 and comprising the periodic, semi-periodic, and/or aperiodic monitoring channel or interference resources (e.g., CSI-RSs, SSBs, CSI-RSs, etc.) on one or more subsets of the prediction resources configured for the performance monitoring. In an illustrative example, the UE 104 can determine soft rank prediction performance information 660, based on the UE 104 measuring the reference signal(s) 655 transmitted on the prediction resources, and determining a measured soft rank on the prediction resources based on the measurements of the reference signal(s) 655 transmitted for the performance monitoring.

In an illustrative example, the soft rank prediction performance 660 can be determined or calculated as a prediction performance based on comparing the predicted soft rank reported by the UE in the report 635 of the soft rank prediction information, to the soft rank measured by the UE 104 on the prediction resources using the monitoring reference signals 655. In some aspects, the monitoring performance for determining the soft rank prediction performance 660 can be calculated using various error metrics between the measured soft rank and the predicted soft rank determined by the UE 104 for the prediction resources. The error metric can be configured by the network entity 102 for the UE 104, for example via the configuration information 610 or a separate configuration. In some aspects, the error metric for the soft rank prediction performance 660 can be an absolute or squared error between predicted soft rank on the prediction resources and the measured soft rank measured using the monitoring reference signal(s) 655 on the prediction resources. In some examples, the UE 104 can determine the soft rank prediction performance 660 based on averaging error or performance information of the soft rank prediction on multiple monitoring occasions of the reference signal(s) 655 on the prediction resources. In some cases, the UE can report the soft rank prediction performance 660 to the network entity 102 via a soft rank prediction performance report 665. The soft rank prediction performance report 665 can indicate one or multiple error metric values determined by the UE 104 between the measured soft rank and the predicted soft rank, and can include the error or performance information of the soft rank prediction on one monitoring occasion or multiple monitoring occasions of the monitoring reference signal(s) 655 on the prediction resources, including an average thereof, etc. In some examples, the UE 104 can be configured to monitor the soft rank prediction performance 660 based on channel prediction information only, based on channel measurement and interference prediction information, and/or based on both channel prediction information and channel prediction information, etc.

In some aspects, based on the soft rank prediction performance information 660 and/or the configured soft rank prediction performance monitoring, the UE 104 can be configured to determine one or more adjustments or updates to the soft rank prediction 630 algorithm(s) and/or ML/AI model(s) used to determine inference outputs corresponding to the soft rank prediction(s) 630. For example, the UE 104 can update the soft rank prediction model or soft rank prediction configuration at block 670, where the update is according to the soft rank prediction performance 660 determined by the UE 104 and reported to the network entity 102 as the soft rank prediction performance report 665. In some aspects, the update 670 can correspond to the UE 104 determining to continue using the same AI/ML model for the soft rank prediction(s) 630, may correspond to the UE 104 determining to finetune the current AI/ML model used for the soft rank prediction(s) 630 to improve the soft rank prediction performance 660, may correspond to the UE 104 determining to switch from the current AI/ML model (e.g., a first AI/ML soft rank prediction model) to a different AI/ML model (e.g., a second AI/ML soft rank prediction model) to improve the soft rank prediction performance 660, may correspond to the UE 104 determining to fall back to non-AI/ML model-based soft rank prediction(s) 630, and/or can correspond to the UE 104 receiving a new (e.g., updated or different, etc.) AI/ML model for soft rank prediction 630 from the network entity 102. The network entity 102 can transmit the new (e.g., updated or different) AI/ML model for soft rank prediction 630 to the UE 104, based on the network entity 102 receiving and analyzing the soft rank prediction performance report 665 indicative of the soft rank prediction performance 660 from the UE 104.

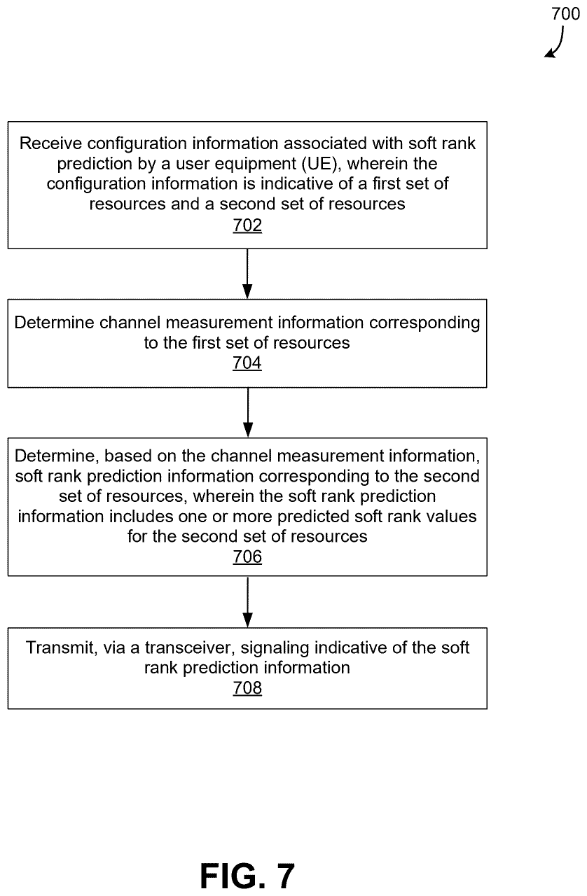

FIG. 7 is a flowchart diagram illustrating an example of a process 700 for wireless communications. In some aspects, the process 700 can be a process for wireless communications by a network device (e.g., a UE, etc.). For example, the process 700 can be a process for wireless communications by a UE. In some examples, the process 700 can be performed by a network entity or network device (or apparatus) or a component (e.g., a chipset, codec, etc.) of the network entity or device. The process 700 can be performed by one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the network entity or device or apparatus. The operations of the process 700 may be implemented as software components that are executed and run on one or more processors (e.g., processor 910 and/or processing system 902 of FIG. 9, or other processor(s)).

In some examples, the process 700 can be performed by a UE, including any of the various UEs described herein. In some aspects, the process 700 can be performed by a UE, smartphone, mobile computing device, user computer device, etc. The process 700 can be performed by a component or system (e.g., a chipset) of a network device (e.g., one or more of UEs 104, 152, 164, 182, 190 of FIG. 1; UE 104 of FIG. 2; UE(s) 104 of FIG. 3; wireless device 407 of FIG. 4; UE 104 of FIG. 6; computing system 900 and/or processing system 902 of FIG. 9; etc.). The process 700 can be performed by a UE or other network device, where the network device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors (e.g., the transmit processor 264, the receive processor 258, the TX MIMO processor 266, the MIMO detector 256 of FIG. 2, the processing system 470 of FIG. 4, the processor(s) 484 of FIG. 4, the processing system 902 of FIG. 9, and/or the processor 910 of FIG. 9, or other processor(s) (e.g., such as one or more other processors included within and/or associated with the processing system 470 of FIG. 4, the processing system 902 of FIG. 9, etc.). Further, the transmission and reception of signals by the network entity in the process 700 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 940 of FIG. 9, or other antennae(s), transceiver(s), and/or component(s)).

At block 702, the apparatus (or component thereof) can receive configuration information associated with soft rank prediction by the UE, wherein the configuration information is indicative of a first set of resources and a second set of resources. For example, the apparatus can correspond to the UE 104 of FIG. 6, and the configuration information can correspond to the configuration information 610 of FIG. 6. In some cases, the first set of resources can correspond to the channel measurement resources 620 of FIG. 6. In some examples, the second set of resources can correspond to prediction resources associated with the soft rank prediction(s) 630 of FIG. 6.

In some cases, the first set of resources comprises a plurality of channel measurement resources indicated by the configuration information and associated with a multiple-input multiple-output (MIMO) channel. In some examples, the second set of resources comprises a plurality of prediction resources indicated by the configuration information and associated with the MIMO channel.

In some cases, the configuration information is received from a network entity associated with a multiple-input multiple-output (MIMO) channel. For example, the configuration information can correspond to the configuration information 610 received from the network entity 102 of FIG. 6. In some examples, the configuration information is indicative of a plurality of synchronization signal block (SSB) or channel state information (CSI) resources. The configuration information may be indicative of a first spatial domain sub-configuration of the plurality of SSB or CSI resources, where the first set of resources comprises the plurality of SSB or CSI resources using the first spatial domain sub-configuration, and may be indicative of a second spatial domain sub-configuration of the plurality of SSB or CSI resources, where the second set of resources comprises the plurality of SSB or CSI resources using the second spatial domain sub-configuration.

In some cases, the configuration information is indicative of a configured soft rank prediction metric for soft rank prediction by the UE. For example, the configured soft rank prediction metric can correspond to the soft rank prediction metric 608 of FIG. 6, and the soft rank prediction by the UE can correspond to the soft rank prediction(s) 630 of FIG. 6. In some cases, the soft rank prediction information and one or more predicted soft rank values are determined according to the configured soft rank prediction metric.

In some cases, the configuration information includes one or more metric indications corresponding to the soft rank prediction by the UE. The one or more metric indications can include at least one of: a configured threshold for the one or more predicted soft rank values, a codebook of values corresponding to the soft rank prediction by the UE, or an input configuration corresponding to the soft rank prediction by the UE.

In some cases, to receive the configuration information, the apparatus (or component thereof) is configured to receive a channel state information (CSI) resource configuration or a CSI report configuration. For example, the configuration information 610 of FIG. 6 can correspond to the CSI resource configuration or the CSI report configuration, where the configuration information is included in the CSI resource configuration or the CSI report configuration.

In some cases, to receive the configuration information, the apparatus (or component thereof) can be configured to receive a channel state information (CSI) resource configuration corresponding to a plurality of resources, where the first set of resources is included in the plurality of resources and mapped to a first value of an identification bit included in the CSI resource configuration, and where the second set of resources is included in the plurality of resources and mapped to a second value of an identification bit included in the CSI resource configuration.

At block 704, the apparatus (or component thereof) can determine channel measurement information corresponding to the first set of resources. For example, the channel measurement information can correspond to the channel measurement information 622 corresponding to the channel measurement resources 620 of FIG. 6.

In some cases, the channel measurement information comprises at least one of: channel measurements of one or more channel measurement resources of the first set of resources, or interference measurements determined corresponding to the one or more channel measurement resources. In some cases, the channel measurement information includes: one or more channel measurements determined corresponding to a subset of channel measurement resources included in the first set of resources, and one or more interference measurements determined corresponding to a subset of interference measurement resources included in the first set of resources.

In some examples, the subset of channel measurement resources comprises one or more synchronization signal block (SSB) resources or channel state information (CSI) reference signal (CSI-RS) resources indicated by the configuration information. In some examples, the subset of interference measurement resources comprises one or more CSI interference measurement (CSI-IM) resources indicated by the configuration information. In some cases, the channel measurement information includes one or more multi-user multiple-input multiple-output (MU-MIMO) interference measurements determined based on a subset of MU-MIMO interference measurement resources included in the first set of resources.

At block 706, the apparatus (or component thereof) can determine, based on the channel measurement information, soft rank prediction information corresponding to the second set of resources, wherein the soft rank prediction information includes one or more predicted soft rank values for the second set of resources. For example, the soft rank prediction information corresponding to the second set of resources can be the same as or similar to the soft rank prediction(s) 630 of FIG. 6, and/or the reported soft rank prediction information 635 of FIG. 6, corresponding to and/or indicative of one or more predicted soft rank values for the prediction resources.

In some examples, the one or more predicted soft rank values are determined using channel prediction information corresponding to the plurality of prediction resources. In some cases, the one or more predicted soft rank values correspond to the plurality of prediction resources. The one or more predicted soft rank values may be determined based on channel prediction information corresponding to a first subset of the plurality of prediction resources and interference prediction information corresponding to a second subset of the plurality of prediction resources.

In some cases, the configuration information is indicative of a configured soft rank prediction metric for the soft rank prediction by the UE, and the soft rank prediction information and the one or more predicted soft rank values are determined according to the configured soft rank prediction metric. In some examples, the configuration information includes one or more metric indications corresponding to the soft rank prediction by the UE, and the one or more metric indications include at least one of: a configured threshold for the one or more predicted soft rank values, a codebook of values corresponding to the soft rank prediction by the UE, or an input configuration corresponding to the soft rank prediction by the UE.

In some examples, based on the input configuration, the apparatus (or component thereof) is configured to perform the soft rank prediction to determine the soft rank prediction information based on the channel measurement information corresponding to the first set of resources and without using interference information corresponding to the first set of resources. In some examples, based on the input configuration, the apparatus (or component thereof) is configured to perform the soft rank prediction to determine the soft rank prediction information based on inputs comprising channel components and interference components determined for the first set of resources. In some examples, the channel components and the interference components are included in the channel measurement information corresponding to the first set of resources. The channel components can include at least one of channel measurements or channel predictions determined for one or more resources of the first set of resources. The interference components can include at least one of interference measurements or interference predictions determined for one or more resources of the first set of resources.

At block 708, the apparatus (or component thereof) can transmit, via the transceiver, signaling indicative of the soft rank prediction information. For example, the signaling can correspond to the reported soft rank prediction information 635 of FIG. 6. In some examples, the signaling indicative of the soft rank prediction information is transmitted to the network entity (e.g., the network entity 102 of FIG. 6, etc.).

In some cases, to transmit the signaling indicative of the soft rank prediction information, the apparatus (or component thereof) can be configured to transmit, via the transceiver, a channel state information (CSI) report including a respective report quantity for each predicted soft rank value of the one or more predicted soft rank values.

In some cases, the apparatus (or component thereof) can be configured to determine confidence level information corresponding to the one or more predicted soft rank values. For example, the confidence level information can be determined corresponding to the soft rank prediction(s) 630 of FIG. 6. In some examples, the confidence level information can be included in the signaling indicative of the soft rank prediction information (e.g., the reported soft rank prediction information 635 of FIG. 6).

In some cases, the apparatus (or component thereof) can be configured to transmit the signaling indicative of the soft rank prediction information to a network entity (e.g., network entity 102 of FIG. 6, etc.). The apparatus (or component thereof) can be configured to measure one or more reference signals on a portion of the second set of resources to obtain a second channel measurement information, wherein the one or more reference signals are configured by the network entity based on the soft rank prediction information. For example, the apparatus (or component thereof) can measure the reference signal(s) 655 on the prediction resources of FIG. 6. The apparatus (or component thereof) can determine a soft rank prediction performance based on a comparison between the second channel measurement information and the soft rank prediction information. For example, the soft rank prediction performance can be determined corresponding to the soft rank prediction performance 660 of FIG. 6.

In some examples, the soft rank prediction performance corresponds to an error metric determined between a predicted soft rank based on the soft rank prediction information, and a measured soft rank based on the second channel measurement information. In some examples, the apparatus (or component thereof) can be configured to transmit, via the transceiver, information indicative of the soft rank prediction performance. For example, the information may correspond to the reported soft rank prediction performance 665 of FIG. 6. In some examples, the apparatus (or component thereof) can be configured to transmit, to the network entity, a request for monitoring resources corresponding to the one or more reference signals on the portion of the second set of resources, and measure the one or more reference signals based on the request for monitoring resources.

In some cases, the apparatus (or component thereof) can be configured to determine the soft rank prediction information using a first machine learning (ML) or artificial intelligence (AI) model. Based on the soft rank prediction performance, the apparatus can determine an updated ML or AI model for soft rank prediction, wherein the updated ML or AI model comprises a second ML or AI model different from the first ML or AI model, or a finetuned ML or AI model generated based on finetuning the first ML or AI model based on the soft rank prediction performance. For example, the UE 104 can update the soft rank prediction model or soft rank prediction configuration at block 670, where the update is according to the soft rank prediction performance 660 determined by the UE 104 and reported to the network entity 102 as the soft rank prediction performance report 665.

In some cases, the signaling includes one or more bits indicative of a reported soft rank type corresponding to predicted values or measured values, and wherein a first value of the one or more bits indicates the reported soft rank type corresponding to predicted values. In some examples, the apparatus (or component thereof) can be configured to transmit, via the transceiver, capability information associated with the soft rank prediction by the UE, where the configuration information is based on the capability information. In some cases, the capability information is indicative of one or more metrics or thresholds corresponding to the soft rank prediction by the UE.

In some examples, the second set of resources includes one or more groups of resource elements (REs), and to determine the soft rank prediction information, the apparatus (or component thereof) can be configured to determine a respective predicted soft rank value for each group of REs of the one or more groups of REs. In some cases, the signaling indicative of the soft rank prediction information is a soft rank prediction report, the soft rank prediction report including a vector indicative of the respective predicted soft rank value for each group of REs. In some cases, the signaling indicative of the soft rank prediction information includes a vector of predicted soft rank values corresponding to one or more subsets of resources of the second set of resources, and the configuration information is indicative of a mapping between the one or more subsets of resources and at least one of: sub-bands of the second set of resources, precoding resource groups (PRGs) of the second set of resources, or resource block groups (RBGs) of the second set of resources.

In some examples, the signaling indicative of the soft rank prediction information includes a vector of predicted soft rank values corresponding to one or more subsets of resources of the second set of resources. The one or more subsets can comprise subsets of resources corresponding to respective sub-bands of the second set of resources, and wherein the vector of predicted soft rank values includes a predicted soft rank value for each respective sub-band, or the one or more subsets can comprise subsets of resources corresponding to respective precoding resource groups (PRGs) or resource block groups (RBGs) of the second set of resources. The vector of predicted soft rank values can include a predicted soft rank value for each respective PRG or each respective RBG.

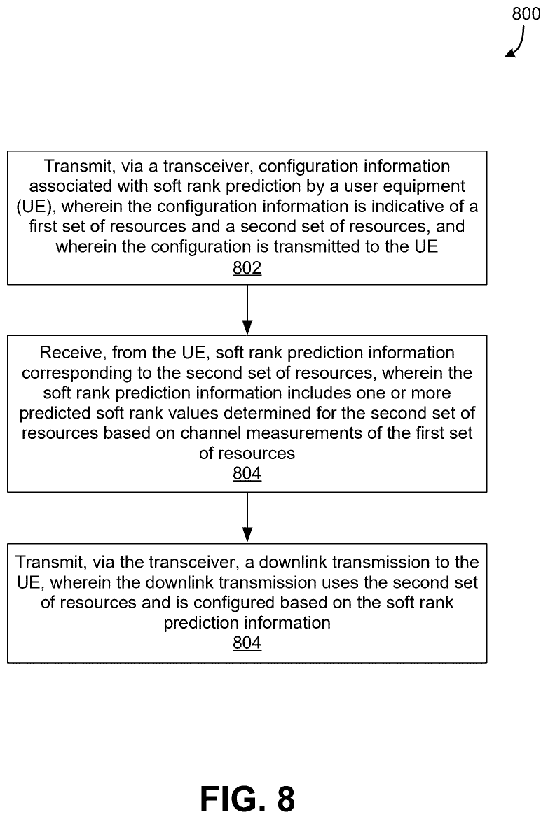

FIG. 8 is a flowchart diagram illustrating an example of a process 800 for wireless communication. The process 800 may be performed by a network entity or network device (or apparatus) or a component (e.g., a chipset, codec, etc.) of the network entity or device. In some examples, the network entity and/or device may be a receiver configured to and/or capable of receiving one or more wireless signals using a wireless communication network. For example, the network entity may be a base station and/or network node (e.g., eNB, gNB, etc.). In some examples, the process 800 may be performed by a network entity or network device (or apparatus) or a component (e.g., a chipset, codec, etc.) of the network entity or device. For example, the apparatus and/or device may be a network entity such as a base station (e.g., an eNB, a gNB, etc.) or a portion of a base station (e.g., one or more of a CU, a DU, a RU, a Near-RT RIC, and/or a Non-RT RIC, such as the CU 310, the DU 330, the RU 340, the Near-RT RIC 325, and/or the Non-RT RIC 315 of the disaggregated base station 300 of FIG. 3), server device, or other network entity.

In some examples, the process 800 can be performed by an apparatus of a network entity (or component thereof). The apparatus can be a mobile device (e.g., a mobile phone), a network-connected wearable such as a watch, an extended reality (XR) device (e.g., a virtual reality (VR) device or augmented reality (AR) device), a vehicle or component or system of a vehicle, or other type of computing device configured to perform wireless communications. The operations of the process 800 may be implemented as software components that are executed and run on one or more processors (e.g., one or more of the transmit processor 264, the receive processor 258, the TX MIMO processor 266, the MIMO detector 256 of FIG. 2, the processing system 470 of FIG. 4, the processor(s) 484 of FIG. 4, the processing system 902 of FIG. 9, and/or the processor 910 of FIG. 9, or other processor(s) (e.g., such as one or more other processors included within and/or associated with the processing system 470 of FIG. 4, the processing system 902 of FIG. 9, etc.)). Further, the transmission and reception of signals by the apparatus and/or device in the process 800 may be enabled, for example, by one or more antennas, one or more transceivers (e.g., wireless transceiver(s)), and/or other communication components (e.g., one or more of the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 940 of FIG. 9, or other antennae(s), transceiver(s), and/or component(s)).

At block 802, the apparatus (or component thereof) can transmit, via the transceiver, configuration information associated with soft rank prediction by a user equipment (UE), wherein the configuration information is indicative of a first set of resources and a second set of resources, and wherein the configuration is transmitted to the UE. For example, the apparatus can correspond to the network entity 102 of FIG. 6, and the configuration information can correspond to the configuration information 610 of FIG. 6. In some examples, block 802 of the process 800 of FIG. 8 can correspond to block 702 of the process 700 of FIG. 7.

At block 804, the apparatus (or component thereof) can receive, from the UE, soft rank prediction information corresponding to the second set of resources, wherein the soft rank prediction information includes one or more predicted soft rank values determined for the second set of resources based on channel measurements of the first set of resources. In some examples, block 804 of the process 800 of FIG. 8 can correspond to one or more of block 704 and/or 706 and/or 708 of the process 700 of FIG. 7. For example, the network entity 102 of FIG. 6 can receive the reported soft rank prediction information 635 of FIG. 6, from the UE 104 of FIG. 6.

At block 806, the apparatus (or component thereof) can transmit, via the transceiver, a downlink transmission to the UE, wherein the downlink transmission uses the second set of resources and is configured based on the soft rank prediction information. For example, the network entity 102 can transmit a downlink transmission corresponding to the reference signal(s) 655 of FIG. 6, transmitted from the network entity 102 to the UE 104 and configured based on the soft rank prediction information 635 reported from the UE 104 to the network entity 102, etc.

In some examples, the processes described herein (e.g., process 700 and/or process 800 and/or other process described herein) may be performed by a computing device or apparatus (e.g., a network node such as a UE, base station, a portion of a base station, etc.). For example, as noted above, the process 700 may be performed by a UE and/or network device, and the process 800 may be performed by a network entity (e.g., base station, gNB, etc.) and/or network node. In some examples, the process 700 and/or the process 800 may be performed by a computing device with the computing system 900 shown in FIG. 9. For example, a wireless communication device with the computing architecture shown in FIG. 9 may include the components of the UE and/or the network entity (e.g., base station, gNB, etc.) and may implement the operations of FIG. 7 and process 700 and/or the operations of FIG. 8 and process 800, etc.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 700 and the process 800 are illustrated as a logical flow diagram, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 700 and/or the process 800 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900 including a processing system 902, which may be for example any computing device making up internal computing system, a remote computing system, a camera, or any component thereof in which the components of the system are in communication with each other using connection 905. Connection 905 may be a physical connection using a bus, or a direct connection into processor 910 (and/or one or more other processors included within and/or associated with the processing system 902), such as in a chipset architecture. Connection 905 may also be a virtual connection, networked connection, or logical connection.

In some aspects, computing system 900 and/or the processing system 902 can be provided as a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

The example processing system 902 includes at least one processing unit (CPU or processor) 910 and connection 905 that communicatively couples various system components including system memory 915, such as read-only memory (ROM) 920 and random access memory (RAM) 925 to processor 910. The processing system 902 may include a cache 912 of high-speed memory connected directly with, in close proximity to, or integrated as part of processor 910 and/or one or more other processors included within and/or associated with the processing system 902.

Processor 910 may include any general-purpose processor and a hardware service or software service, such as services 932, 934, and 936 stored in storage device 930, configured to control processor 910 and/or one or more other processors included within and/or associated with the processing system 902, as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, processing system 902 includes an input device 945, which may represent any number of input mechanisms, such as a microphone for speech, a touch-sensitive screen for gesture or graphical input, keyboard, mouse, motion input, speech, etc. Processing system 902 may also include output device 935, which may be one or more of a number of output mechanisms. In some examples, multimodal systems may enable a user to provide multiple types of input/output to communicate with processing system 902.

Processing system 902 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard, and Visa (EMV) chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (LI) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910 and/or one or more other processors included within and/or associated with the processing system 902, it causes the system to perform a function. In some aspects, a hardware service that performs a particular function may include the software component stored in a computer-readable medium in connection with the necessary hardware components, such as processor 910 (e.g., and/or one or more other processors included within and/or associated with the processing system 902), connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some examples the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other examples, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for wireless communication at a user equipment (UE), comprising: a processing system; and a transceiver in communication with the processing system, the processing system configured to: receive configuration information associated with soft rank prediction by the UE, wherein the configuration information is indicative of a first set of resources and a second set of resources; determine channel measurement information corresponding to the first set of resources; determine, based on the channel measurement information, soft rank prediction information corresponding to the second set of resources, wherein the soft rank prediction information includes one or more predicted soft rank values for the second set of resources; and transmit, via the transceiver, signaling indicative of the soft rank prediction information.

Aspect 2. The apparatus of Aspect 1, wherein: the first set of resources comprises a plurality of channel measurement resources indicated by the configuration information and associated with a multiple-input multiple-output (MIMO) channel; and the second set of resources comprises a plurality of prediction resources indicated by the configuration information and associated with the MIMO channel.

Aspect 3. The apparatus of Aspect 2, wherein the one or more predicted soft rank values are determined using channel prediction information corresponding to the plurality of prediction resources.

Aspect 4. The apparatus of any of Aspects 2 to 3, wherein: the one or more predicted soft rank values correspond to the plurality of prediction resources; and the one or more predicted soft rank values are determined based on channel prediction information corresponding to a first subset of the plurality of prediction resources and interference prediction information corresponding to a second subset of the plurality of prediction resources.

Aspect 5. The apparatus of any of Aspects 1 to 4, wherein the channel measurement information comprises at least one of: channel measurements of one or more channel measurement resources of the first set of resources; or interference measurements determined corresponding to the one or more channel measurement resources.

Aspect 6. The apparatus of any of Aspects 1 to 5, wherein the channel measurement information includes: one or more channel measurements determined corresponding to a subset of channel measurement resources included in the first set of resources; and one or more interference measurements determined corresponding to a subset of interference measurement resources included in the first set of resources.

Aspect 7. The apparatus of Aspect 6, wherein: the subset of channel measurement resources comprises one or more synchronization signal block (SSB) resources or channel state information (CSI) reference signal (CSI-RS) resources indicated by the configuration information; and the subset of interference measurement resources comprises one or more CSI interference measurement (CSI-IM) resources indicated by the configuration information.

Aspect 8. The apparatus of any of Aspects 6 to 7, wherein the channel measurement information includes one or more multi-user multiple-input multiple-output (MU-MIMO) interference measurements determined based on a subset of MU-MIMO interference measurement resources included in the first set of resources.

Aspect 9. The apparatus of any of Aspects 1 to 8, wherein: the configuration information is received from a network entity associated with a multiple-input multiple-output (MIMO) channel; and the signaling indicative of the soft rank prediction information is transmitted to the network entity.

Aspect 10. The apparatus of any of Aspects 1 to 9, wherein the configuration information is indicative of: a plurality of synchronization signal block (SSB) or channel state information (CSI) resources; a first spatial domain sub-configuration of the plurality of SSB or CSI resources, wherein the first set of resources comprises the plurality of SSB or CSI resources using the first spatial domain sub-configuration; and a second spatial domain sub-configuration of the plurality of SSB or CSI resources, wherein the second set of resources comprises the plurality of SSB or CSI resources using the second spatial domain sub-configuration.

Aspect 11. The apparatus of any of Aspects 1 to 10, wherein: the configuration information is indicative of a configured soft rank prediction metric for the soft rank prediction by the UE; and the soft rank prediction information and the one or more predicted soft rank values are determined according to the configured soft rank prediction metric.

Aspect 12. The apparatus of Aspect 11, wherein the configuration information includes one or more metric indications corresponding to the soft rank prediction by the UE, and wherein the one or more metric indications include at least one of: a configured threshold for the one or more predicted soft rank values, a codebook of values corresponding to the soft rank prediction by the UE, or an input configuration corresponding to the soft rank prediction by the UE.

Aspect 13. The apparatus of Aspect 12, wherein, based on the input configuration, the processing system is configured to perform the soft rank prediction to determine the soft rank prediction information based on the channel measurement information corresponding to the first set of resources and without using interference information corresponding to the first set of resources.

Aspect 14. The apparatus of any of Aspects 12 to 13, wherein, based on the input configuration, the processing system is configured to perform the soft rank prediction to determine the soft rank prediction information based on inputs comprising channel components and interference components determined for the first set of resources.

Aspect 15. The apparatus of Aspect 14, wherein: the channel components and the interference components are included in the channel measurement information corresponding to the first set of resources; the channel components include at least one of channel measurements or channel predictions determined for one or more resources of the first set of resources; and the interference components include at least one of interference measurements or interference predictions determined for one or more resources of the first set of resources.

Aspect 16. The apparatus of any of Aspects 1 to 15, wherein: to receive the configuration information, the processing system is configured to receive a channel state information (CSI) resource configuration or a CSI report configuration; and the configuration information is included in the CSI resource configuration or the CSI report configuration.

Aspect 17. The apparatus of any of Aspects 1 to 16, wherein: to receive the configuration information, the processing system is configured to receive a channel state information (CSI) resource configuration corresponding to a plurality of resources; the first set of resources is included in the plurality of resources and mapped to a first value of an identification bit included in the CSI resource configuration; and the second set of resources is included in the plurality of resources and mapped to a second value of an identification bit included in the CSI resource configuration.

Aspect 18. The apparatus of any of Aspects 1 to 17, wherein, to transmit the signaling indicative of the soft rank prediction information, the processing system is configured to: transmit, via the transceiver, a channel state information (CSI) report including a respective report quantity for each predicted soft rank value of the one or more predicted soft rank values.

Aspect 19. The apparatus of any of Aspects 1 to 18, wherein: the processing system is configured to determine confidence level information corresponding to the one or more predicted soft rank values; and the confidence level information is included in the signaling indicative of the soft rank prediction information.

Aspect 20. The apparatus of any of Aspects 1 to 19, wherein the processing system is configured to: transmit the signaling indicative of the soft rank prediction information to a network entity; measure one or more reference signals on a portion of the second set of resources to obtain a second channel measurement information, wherein the one or more reference signals are configured by the network entity based on the soft rank prediction information; and determine a soft rank prediction performance based on a comparison between the second channel measurement information and the soft rank prediction information.

Aspect 21. The apparatus of Aspect 20, wherein: the soft rank prediction performance corresponds to an error metric determined between a predicted soft rank based on the soft rank prediction information, and a measured soft rank based on the second channel measurement information.

Aspect 22. The apparatus of any of Aspects 20 to 21, wherein the processing system is configured to transmit, via the transceiver, information indicative of the soft rank prediction performance.

Aspect 23. The apparatus of any of Aspects 20 to 22, wherein the processing system is configured to: transmit, to the network entity, a request for monitoring resources corresponding to the one or more reference signals on the portion of the second set of resources; and measure the one or more reference signals based on the request for monitoring resources.

Aspect 24. The apparatus of any of Aspects 20 to 23, wherein the processing system is configured to: determine the soft rank prediction information using a first machine learning (ML) or artificial intelligence (AI) model; and based on the soft rank prediction performance, determine an updated ML or AI model for soft rank prediction, wherein the updated ML or AI model comprises: a second ML or AI model different from the first ML or AI model; or a finetuned ML or AI model generated based on finetuning the first ML or AI model based on the soft rank prediction performance.

Aspect 25. The apparatus of any of Aspects 1 to 24, wherein the signaling includes one or more bits indicative of a reported soft rank type corresponding to predicted values or measured values, and wherein a first value of the one or more bits indicates the reported soft rank type corresponding to predicted values.

Aspect 26. The apparatus of any of Aspects 1 to 25, wherein the processing system is configured to transmit, via the transceiver, capability information associated with the soft rank prediction by the UE, and wherein the configuration information is based on the capability information.

Aspect 27. The apparatus of Aspect 26, wherein the capability information is indicative of one or more metrics or thresholds corresponding to the soft rank prediction by the UE.

Aspect 28. The apparatus of any of Aspects 1 to 27, wherein: the second set of resources includes one or more groups of resource elements (REs); to determine the soft rank prediction information, the processing system is configured to determine a respective predicted soft rank value for each group of REs of the one or more groups of REs; and the signaling indicative of the soft rank prediction information is a soft rank prediction report, the soft rank prediction report including a vector indicative of the respective predicted soft rank value for each group of REs.

Aspect 29. The apparatus of any of Aspects 1 to 28, wherein: the signaling indicative of the soft rank prediction information includes a vector of predicted soft rank values corresponding to one or more subsets of resources of the second set of resources; and the configuration information is indicative of a mapping between the one or more subsets of resources and at least one of: sub-bands of the second set of resources, precoding resource groups (PRGs) of the second set of resources, or resource block groups (RBGs) of the second set of resources.

Aspect 30. The apparatus of any of Aspects 1 to 29, wherein the signaling indicative of the soft rank prediction information includes a vector of predicted soft rank values corresponding to one or more subsets of resources of the second set of resources, and wherein: the one or more subsets comprise subsets of resources corresponding to respective sub-bands of the second set of resources, and wherein the vector of predicted soft rank values includes a predicted soft rank value for each respective sub-band; or the one or more subsets comprise subsets of resources corresponding to respective precoding resource groups (PRGs) or resource block groups (RBGs) of the second set of resources, and wherein the vector of predicted soft rank values includes a predicted soft rank value for each respective PRG or each respective RBG.

Aspect 31. An apparatus for wireless communication at a network entity, comprising: a processing system; and a transceiver in communication with the processing system, the processing system configured to: transmit, via the transceiver, configuration information associated with soft rank prediction by a user equipment (UE), wherein the configuration information is indicative of a first set of resources and a second set of resources, and wherein the configuration is transmitted to the UE; receive, from the UE, soft rank prediction information corresponding to the second set of resources, wherein the soft rank prediction information includes one or more predicted soft rank values determined for the second set of resources based on channel measurements of the first set of resources; and transmit, via the transceiver, a downlink transmission to the UE, wherein the downlink transmission uses the second set of resources and is configured based on the soft rank prediction information.

Aspect 32. A method for wireless communication at a user equipment (UE), the method comprising: receiving configuration information associated with soft rank prediction by the UE, wherein the configuration information is indicative of a first set of resources and a second set of resources; determining channel measurement information corresponding to the first set of resources; determining, based on the channel measurement information, soft rank prediction information corresponding to the second set of resources, wherein the soft rank prediction information includes one or more predicted soft rank values for the second set of resources; and transmitting, via a transceiver, signaling indicative of the soft rank prediction information.

Aspect 33. The method of Aspect 32, wherein: the first set of resources comprises a plurality of channel measurement resources indicated by the configuration information and associated with a multiple-input multiple-output (MIMO) channel; and the second set of resources comprises a plurality of prediction resources indicated by the configuration information and associated with the MIMO channel.

Aspect 34. The method of Aspect 33, wherein the one or more predicted soft rank values are determined using channel prediction information corresponding to the plurality of prediction resources.

Aspect 35. The method of any of Aspects 33 to 34, wherein: the one or more predicted soft rank values correspond to the plurality of prediction resources; and the one or more predicted soft rank values are determined based on channel prediction information corresponding to a first subset of the plurality of prediction resources and interference prediction information corresponding to a second subset of the plurality of prediction resources.

Aspect 36. The method of any of Aspects 32 to 25, wherein the channel measurement information comprises at least one of: channel measurements of one or more channel measurement resources of the first set of resources; or interference measurements determined corresponding to the one or more channel measurement resources.

Aspect 37. The method of any of Aspects 32 to 26, wherein the channel measurement information includes: one or more channel measurements determined corresponding to a subset of channel measurement resources included in the first set of resources; and one or more interference measurements determined corresponding to a subset of interference measurement resources included in the first set of resources.

Aspect 38. The method of Aspect 37, wherein: the subset of channel measurement resources comprises one or more synchronization signal block (SSB) resources or channel state information (CSI) reference signal (CSI-RS) resources indicated by the configuration information; and the subset of interference measurement resources comprises one or more CSI interference measurement (CSI-IM) resources indicated by the configuration information.

Aspect 39. The method of any of Aspects 37 to 38, wherein the channel measurement information includes one or more multi-user multiple-input multiple-output (MU-MIMO) interference measurements determined based on a subset of MU-MIMO interference measurement resources included in the first set of resources.

Aspect 40. The method of any of Aspects 32 to 39, wherein: the configuration information is received from a network entity associated with a multiple-input multiple-output (MIMO) channel; and the signaling indicative of the soft rank prediction information is transmitted to the network entity.

Aspect 41. The method of any of Aspects 32 to 40, wherein the configuration information is indicative of: a plurality of synchronization signal block (SSB) or channel state information (CSI) resources; a first spatial domain sub-configuration of the plurality of SSB or CSI resources, wherein the first set of resources comprises the plurality of SSB or CSI resources using the first spatial domain sub-configuration; and a second spatial domain sub-configuration of the plurality of SSB or CSI resources, wherein the second set of resources comprises the plurality of SSB or CSI resources using the second spatial domain sub-configuration.

Aspect 42. The method of any of Aspects 32 to 41, wherein: the configuration information is indicative of a configured soft rank prediction metric for the soft rank prediction by the UE; and the soft rank prediction information and the one or more predicted soft rank values are determined according to the configured soft rank prediction metric.

Aspect 43. The method of Aspect 42, wherein the configuration information includes one or more metric indications corresponding to the soft rank prediction by the UE, and wherein the one or more metric indications include at least one of: a configured threshold for the one or more predicted soft rank values, a codebook of values corresponding to the soft rank prediction by the UE, or an input configuration corresponding to the soft rank prediction by the UE.

Aspect 44. The method of Aspect 43, wherein, based on the input configuration, the UE is configured to perform the soft rank prediction to determine the soft rank prediction information based on the channel measurement information corresponding to the first set of resources and without using interference information corresponding to the first set of resources.

Aspect 45. The method of any of Aspects 43 to 44, wherein, based on the input configuration, the UE is configured to perform the soft rank prediction to determine the soft rank prediction information based on inputs comprising channel components and interference components determined for the first set of resources.

Aspect 46. The method of Aspect 45, wherein: the channel components and the interference components are included in the channel measurement information corresponding to the first set of resources; the channel components include at least one of channel measurements or channel predictions determined for one or more resources of the first set of resources; and the interference components include at least one of interference measurements or interference predictions determined for one or more resources of the first set of resources.

Aspect 47. The method of any of Aspects 32 to 46, wherein: receiving the configuration information includes receiving a channel state information (CSI) resource configuration or a CSI report configuration; and the configuration information is included in the CSI resource configuration or the CSI report configuration.

Aspect 48. The method of any of Aspects 32 to 47, wherein: receiving the configuration information includes receiving a channel state information (CSI) resource configuration corresponding to a plurality of resources; the first set of resources is included in the plurality of resources and mapped to a first value of an identification bit included in the CSI resource configuration; and the second set of resources is included in the plurality of resources and mapped to a second value of an identification bit included in the CSI resource configuration.

Aspect 49. The method of any of Aspects 32 to 48, wherein transmitting the signaling indicative of the soft rank prediction information includes: transmitting, via the transceiver, a channel state information (CSI) report including a respective report quantity for each predicted soft rank value of the one or more predicted soft rank values.

Aspect 50. The method of any of Aspects 32 to 49, wherein: the UE is configured to determine confidence level information corresponding to the one or more predicted soft rank values; and the confidence level information is included in the signaling indicative of the soft rank prediction information.

Aspect 51. The method of any of Aspects 32 to 50, further comprising: transmitting the signaling indicative of the soft rank prediction information to a network entity; measuring one or more reference signals on a portion of the second set of resources to obtain a second channel measurement information, wherein the one or more reference signals are configured by the network entity based on the soft rank prediction information; and determining a soft rank prediction performance based on a comparison between the second channel measurement information and the soft rank prediction information.

Aspect 52. The method of Aspect 51, wherein: the soft rank prediction performance corresponds to an error metric determined between a predicted soft rank based on the soft rank prediction information, and a measured soft rank based on the second channel measurement information.

Aspect 53. The method of any of Aspects 51 to 52, further comprising transmitting, via the transceiver, information indicative of the soft rank prediction performance.

Aspect 54. The method of any of Aspects 51 to 53, further comprising: transmitting, to the network entity, a request for monitoring resources corresponding to the one or more reference signals on the portion of the second set of resources; and measuring the one or more reference signals based on the request for monitoring resources.

Aspect 55. The method of any of Aspects 51 to 54, further comprising: determining the soft rank prediction information using a first machine learning (ML) or artificial intelligence (AI) model; and based on the soft rank prediction performance, determining an updated ML or AI model for soft rank prediction, wherein the updated ML or AI model comprises: a second ML or AI model different from the first ML or AI model; or a finetuned ML or AI model generated based on finetuning the first ML or AI model based on the soft rank prediction performance.

Aspect 56. The method of any of Aspects 32 to 55, wherein the signaling includes one or more bits indicative of a reported soft rank type corresponding to predicted values or measured values, and wherein a first value of the one or more bits indicates the reported soft rank type corresponding to predicted values.

Aspect 57. The method of any of Aspects 32 to 56, further comprising transmitting, via the transceiver, capability information associated with the soft rank prediction by the UE, and wherein the configuration information is based on the capability information.

Aspect 58. The method of Aspect 57, wherein the capability information is indicative of one or more metrics or thresholds corresponding to the soft rank prediction by the UE.

Aspect 59. The method of any of Aspects 32 to 58, wherein: the second set of resources includes one or more groups of resource elements (REs); determining the soft rank prediction information includes determining a respective predicted soft rank value for each group of REs of the one or more groups of REs; and the signaling indicative of the soft rank prediction information is a soft rank prediction report, the soft rank prediction report including a vector indicative of the respective predicted soft rank value for each group of REs.

Aspect 60. The method of any of Aspects 32 to 59, wherein: the signaling indicative of the soft rank prediction information includes a vector of predicted soft rank values corresponding to one or more subsets of resources of the second set of resources; and the configuration information is indicative of a mapping between the one or more subsets of resources and at least one of: sub-bands of the second set of resources, precoding resource groups (PRGs) of the second set of resources, or resource block groups (RBGs) of the second set of resources.

Aspect 61. The method of any of Aspects 32 to 60, wherein the signaling indicative of the soft rank prediction information includes a vector of predicted soft rank values corresponding to one or more subsets of resources of the second set of resources, and wherein: the one or more subsets comprise subsets of resources corresponding to respective sub-bands of the second set of resources, and wherein the vector of predicted soft rank values includes a predicted soft rank value for each respective sub-band; or the one or more subsets comprise subsets of resources corresponding to respective precoding resource groups (PRGs) or resource block groups (RBGs) of the second set of resources, and wherein the vector of predicted soft rank values includes a predicted soft rank value for each respective PRG or each respective RBG.

Aspect 62. A method for wireless communication at a network entity, the method comprising: transmitting, via a transceiver, configuration information associated with soft rank prediction by a user equipment (UE), wherein the configuration information is indicative of a first set of resources and a second set of resources, and wherein the configuration is transmitted to the UE; receiving, from the UE, soft rank prediction information corresponding to the second set of resources, wherein the soft rank prediction information includes one or more predicted soft rank values determined for the second set of resources based on channel measurements of the first set of resources; and transmitting, via the transceiver, a downlink transmission to the UE, wherein the downlink transmission uses the second set of resources and is configured based on the soft rank prediction information.

Aspect 63. A non-transitory computer-readable storage medium comprising instructions stored thereon which, when executed by at least one processor, causes the at least one processor to perform operations according to any of Aspects 1 to 30.

Aspect 64. An apparatus for wireless communication comprising one or more means for performing operations according to any of Aspects 1 to 30.

What is claimed is:

1. An apparatus for wireless communication at a user equipment (UE), comprising:
a processing system; and
a transceiver in communication with the processing system, the processing system configured to:
receive configuration information associated with soft rank prediction by the UE, wherein the configuration information is indicative of a first set of resources and a second set of resources;
determine channel measurement information corresponding to the first set of resources;
determine, based on the channel measurement information, soft rank prediction information corresponding to the second set of resources, wherein the soft rank prediction information includes one or more predicted soft rank values for the second set of resources; and
transmit, via the transceiver, signaling indicative of the soft rank prediction information.

2. The apparatus of claim 1, wherein:
the first set of resources comprises a plurality of channel measurement resources indicated by the configuration information and associated with a multiple-input multiple-output (MIMO) channel; and
the second set of resources comprises a plurality of prediction resources indicated by the configuration information and associated with the MIMO channel.

3. The apparatus of claim 2, wherein the one or more predicted soft rank values are determined using channel prediction information corresponding to the plurality of prediction resources.

4. The apparatus of claim 2, wherein:
the one or more predicted soft rank values correspond to the plurality of prediction resources; and
the one or more predicted soft rank values are determined based on channel prediction information corresponding to a first subset of the plurality of prediction resources and interference prediction information corresponding to a second subset of the plurality of prediction resources.

5. The apparatus of claim 1, wherein the channel measurement information comprises at least one of:
channel measurements of one or more channel measurement resources of the first set of resources; or
interference measurements determined corresponding to the one or more channel measurement resources.

6. The apparatus of claim 1, wherein the channel measurement information includes:
one or more channel measurements determined corresponding to a subset of channel measurement resources included in the first set of resources; and
one or more interference measurements determined corresponding to a subset of interference measurement resources included in the first set of resources.

7. The apparatus of claim 6, wherein:
the subset of channel measurement resources comprises one or more synchronization signal block (SSB) resources or channel state information (CSI) reference signal (CSI-RS) resources indicated by the configuration information; and
the subset of interference measurement resources comprises one or more CSI interference measurement (CSI-IM) resources indicated by the configuration information.

8. The apparatus of claim 1, wherein:
the configuration information is received from a network entity associated with a multiple-input multiple-output (MIMO) channel; and
the signaling indicative of the soft rank prediction information is transmitted to the network entity.

9. The apparatus of claim 1, wherein the configuration information is indicative of:
a plurality of synchronization signal block (SSB) or channel state information (CSI) resources;
a first spatial domain sub-configuration of the plurality of SSB or CSI resources, wherein the first set of resources comprises the plurality of SSB or CSI resources using the first spatial domain sub-configuration; and
a second spatial domain sub-configuration of the plurality of SSB or CSI resources, wherein the second set of resources comprises the plurality of SSB or CSI resources using the second spatial domain sub-configuration.

10. The apparatus of claim 1, wherein:
the configuration information is indicative of a configured soft rank prediction metric for the soft rank prediction by the UE; and
the soft rank prediction information and the one or more predicted soft rank values are determined according to the configured soft rank prediction metric.

11. The apparatus of claim 1, wherein:
to receive the configuration information, the processing system is configured to receive a channel state information (CSI) resource configuration or a CSI report configuration; and
the configuration information is included in the CSI resource configuration or the CSI report configuration.

12. The apparatus of claim 1, wherein, to transmit the signaling indicative of the soft rank prediction information, the processing system is configured to:
transmit, via the transceiver, a channel state information (CSI) report including a respective report quantity for each predicted soft rank value of the one or more predicted soft rank values.

13. The apparatus of claim 1, wherein:
the processing system is configured to determine confidence level information corresponding to the one or more predicted soft rank values; and
the confidence level information is included in the signaling indicative of the soft rank prediction information.

14. The apparatus of claim 1, wherein the processing system is configured to:
transmit the signaling indicative of the soft rank prediction information to a network entity;
measure one or more reference signals on a portion of the second set of resources to obtain a second channel measurement information, wherein the one or more reference signals are configured by the network entity based on the soft rank prediction information; and
determine a soft rank prediction performance based on a comparison between the second channel measurement information and the soft rank prediction information.

15. The apparatus of claim 1, wherein the signaling includes one or more bits indicative of a reported soft rank type corresponding to predicted values or measured values, and wherein a first value of the one or more bits indicates the reported soft rank type corresponding to predicted values.

16. The apparatus of claim 1, wherein the processing system is configured to transmit, via the transceiver, capability information associated with the soft rank prediction by the UE, and wherein the configuration information is based on the capability information.

17. The apparatus of claim 1, wherein:
the second set of resources includes one or more groups of resource elements (REs);
to determine the soft rank prediction information, the processing system is configured to determine a respective predicted soft rank value for each group of REs of the one or more groups of REs; and
the signaling indicative of the soft rank prediction information is a soft rank prediction report, the soft rank prediction report including a vector indicative of the respective predicted soft rank value for each group of REs.

18. The apparatus of claim 1, wherein the signaling indicative of the soft rank prediction information includes a vector of predicted soft rank values corresponding to one or more subsets of resources of the second set of resources, and wherein:
the one or more subsets comprise subsets of resources corresponding to respective sub-bands of the second set of resources, and wherein the vector of predicted soft rank values includes a predicted soft rank value for each respective sub-band; or
the one or more subsets comprise subsets of resources corresponding to respective precoding resource groups (PRGs) or resource block groups (RBGs) of the second set of resources, and wherein the vector of predicted soft rank values includes a predicted soft rank value for each respective PRG or each respective RBG.

19. A method for wireless communication at a user equipment (UE), the method comprising:
receiving configuration information associated with soft rank prediction by the UE, wherein the configuration information is indicative of a first set of resources and a second set of resources;
determining channel measurement information corresponding to the first set of resources;
determining, based on the channel measurement information, soft rank prediction information corresponding to the second set of resources, wherein the soft rank prediction information includes one or more predicted soft rank values for the second set of resources; and
transmitting, via a transceiver, signaling indicative of the soft rank prediction information.

20. An apparatus for wireless communication at a network entity, comprising:
a processing system; and
a transceiver in communication with the processing system, the processing system configured to:
transmit, via the transceiver, configuration information associated with soft rank prediction by a user equipment (UE), wherein the configuration information is indicative of a first set of resources and a second set of resources, and wherein the configuration is transmitted to the UE;
receive, from the UE, soft rank prediction information corresponding to the second set of resources, wherein the soft rank prediction information includes one or more predicted soft rank values determined for the second set of resources based on channel measurements of the first set of resources; and
transmit, via the transceiver, a downlink transmission to the UE, wherein the downlink transmission uses the second set of resources and is configured based on the soft rank prediction information.
